(19) United States
(12) Patent Application Publication
(10) Pub. No.: US 2011/0320226 A1
(43) Pub. Date: Dec. 29, 2011

(54) SYSTEMS AND METHODS FOR FACILITATING SETTLEMENT OF INSURANCE CLAIMS

(76) Inventors: Christine A. Graziano, Victor, NY (US); Ellen Emory, Washington, PA (US); Jon Gice, Avon, CT (US); Kristin Meehan Thornton, Foxboro, MA (US); David Payne, Woodstock Valley, CT (US)

(21) Appl. No.: 13/167,676

(22) Filed: Jun. 23, 2011

Related U.S. Application Data
(60) Provisional application No. 61/357,970, filed on Jun. 23, 2010.

(51) Int. Cl. G06Q 40/00

(52) U.S. Cl. 705/4

(57) ABSTRACT

Systems, apparatus, methods and articles of manufacture provide for facilitating settlement of insurance claims. According to some embodiments, methods include facilitating settlement with respect to benefits owed by a carrier to a claimant (e.g., based on an injured worker's claim for benefits under a workers' compensation policy) and with respect to a subrogation interest of the carrier in any recovery by the claimant from a third party (e.g., accused of causing the injury).

### CROSS-REFERENCE TO RELATED APPLICATIONS

The present application claims the benefit of priority of U.S. Provisional Patent Application No. 61/357,970 filed Jun. 23, 2010, and entitled “Systems and Methods for Facilitating Settlement of Insurance Claims,” which is incorporated by reference in the present application.

### BACKGROUND

Benefits claimed under an indemnity insurance policy typically allow a claimant to recoup various costs incurred (and/or value lost) by the claimant as a result of an injury, property damage and/or other loss stemming from an injury, accident or other loss event. Benefits may be paid by an insurance company, self-insured employer or other insurance carrier, to cover medical treatment costs, property repair or replacement costs, loss of income, and the like, depending on the loss and coverage afforded by the policy. Sometimes, such as when an insurance carrier is required to pay additional benefits over time to a claimant (e.g., to an injured worker under a workers' compensation program for ongoing medical treatment costs and/or wage loss benefits), the claimant and the insurance carrier may agree to a settlement amount to settle any claimed but unpaid benefits and/or expected future benefits owed to the claimant.

In some instances, in addition to filing a claim for benefits with an insurance carrier, a claimant may bring a lawsuit to recover damages from a third party defendant accused of causing (at least in part) the loss event. In one example, a worker driving an employer's vehicle is injured in an automobile accident caused by another driver during the course of the worker's employment. The injured worker may file a workers' compensation claim with the employer's workers' compensation insurance carrier to recover any medical costs of the claimant related to the accident. Assuming the injured worker has a good case, he or she may also be able to bring a negligence claim against the other driver, seeking monetary recovery for the injuries (among other potential damages claims).

To prevent a claimant (e.g., the injured worker in the example above) from realizing a double recovery from both an insurance carrier and a third party defendant, most jurisdictions recognize a subrogation interest of the insurance carrier in any third party recovery and allow the insurance carrier to recover some or all of the benefits that it has paid to the claimant. Recovery may be facilitated by the insurance carrier's filing of a statutory lien, filing of a complaint in intervention in the third party defendant case or other procedure, depending on the jurisdiction. Also, and depending on the laws of the relevant jurisdiction, if the carrier will be required to pay additional ongoing benefits over time to the claimant (e.g., to cover ongoing medical costs for an injured worker) the insurance carrier may be able to obtain a future credit against some or all of the unpaid benefits owed. The state law of many jurisdictions may allow an insurance carrier to remove from its reserved funds an amount equal to the future credit granted and/or stop paying benefits to the injured worker until the future credit is exhausted; some jurisdictions may require some amount of benefits (e.g., 25% of claimed benefits to cover attorney's fees and other costs) to be paid by the insurance carrier on an ongoing basis to the claimant even when there is future credit remaining that has not been exhausted fully.

Accordingly, in some circumstances an insurance carrier may be required to pay benefits (including future benefits) to a claimant as a result of a loss, and the insurance carrier also may have a lien or other means protecting its subrogation interest in the claimant's recovery from a third party defendant with respect to the same loss event. The claimant and the insurance carrier may find it mutually beneficial to resolve the benefits case and the carrier's subrogation interest, such as in a settlement agreement settling both aspects of the claim. Typically, however, an insurance carrier may rely on claim professionals and information about the benefits owed to settle the benefits issues, while separately relying on subrogation professionals and information about the third party recovery to secure an outcome for the subrogation issues. Despite the importance to insurance carriers of such settlements of benefits claims and subrogation rights, previous practices have failed to recognize the potential of certain information and/or failed to use information available in the respective benefits and subrogation contexts to inform and optimize an outcome resolving both aspects of the claim.

### BRIEF DESCRIPTION OF THE DRAWINGS

An understanding of embodiments described in this disclosure and many of the attendant advantages may be readily obtained by reference to the following detailed description when considered with the accompanying drawings, wherein:

FIG. 1A is a diagram of a system according to some embodiments of the present invention;

FIG. 1B is a diagram of a claim management system according to some embodiments of the present invention;

FIG. 2 is a diagram of a computer system according to some embodiments of the present invention;

FIG. 3 is a diagram of a database according to some embodiments of the present invention;

FIG. 4 is a diagram of a database according to some embodiments of the present invention;

FIG. 5 is a diagram of a database according to some embodiments of the present invention;

FIG. 6 is a flowchart of a method according to some embodiments of the present invention;

FIG. 7 is a flowchart of a method according to some embodiments of the present invention;

FIG. 8 is a flowchart of a method according to some embodiments of the present invention;

FIG. 9A is a flowchart of a method according to some embodiments of the present invention;

FIG. 9B is a flowchart of a method according to some embodiments of the present invention;

FIG. 9C is a flowchart of a method according to some embodiments of the present invention;

FIG. 9D is a flowchart of a method according to some embodiments of the present invention;

FIG. 9E is a flowchart of a method according to some embodiments of the present invention;

FIG. 10 is a flowchart of a method according to some embodiments of the present invention;

FIG. 11A depicts an example user interface according to some embodiments of the present invention;

FIG. 11B depicts an example user interface according to some embodiments of the present invention;

FIG. 12 is a flowchart of a method according to some embodiments of the present invention; and

FIG. 13 depicts an example user interface according to some embodiments of the present invention.

### DETAILED DESCRIPTION

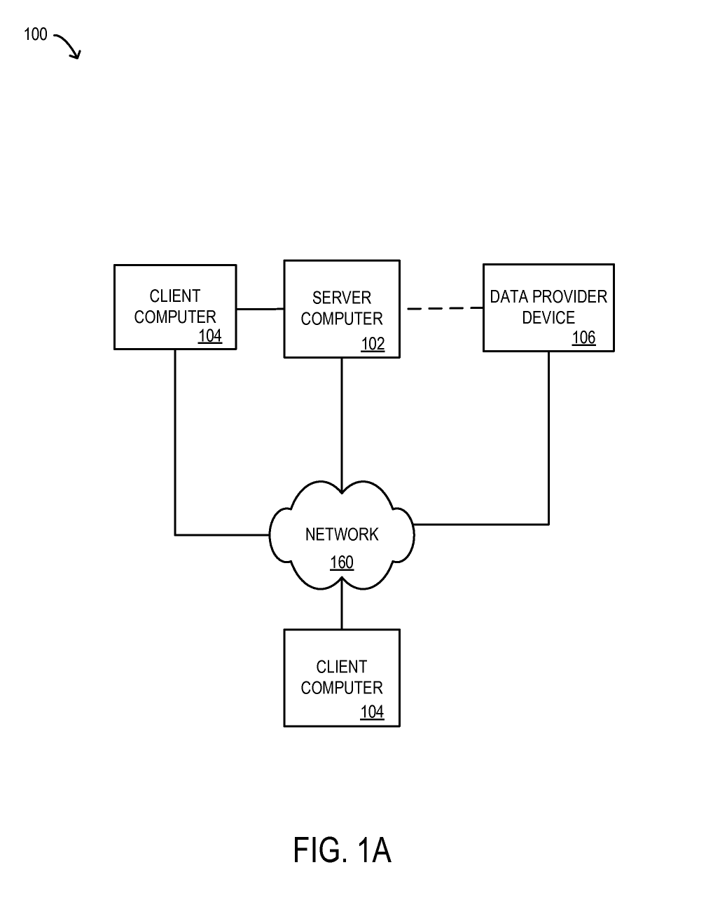

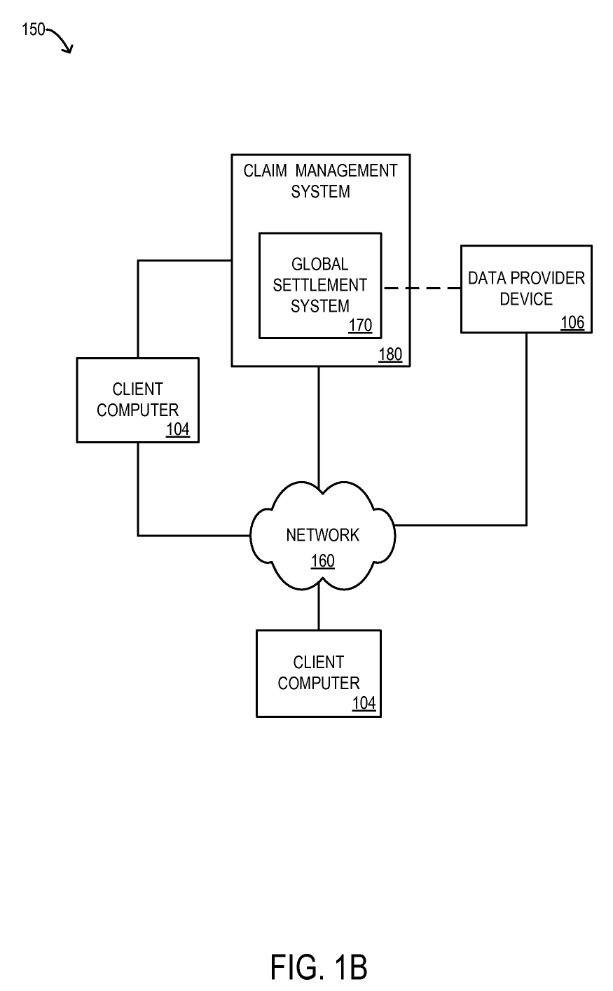

FIG. 1A depicts a block diagram of an example system 100 for facilitating settlement of insurance claims according to some embodiments. The system 100 may comprise one or more client computers 104 in communication with a controller or server computer 102 via a network 160. Typically a processor (e.g., one or more microprocessors, one or more microcontrollers, one or more digital signal processors) of a client computer 104 or server computer 102 will receive instructions (e.g., from a memory or like device), and execute those instructions, thereby performing one or more processes defined by those instructions. Instructions may be embodied in, for example, one or more computer programs and/or one or more scripts.

In some embodiments a server computer 102 and/or one or more of the client computers 104 stores and/or has access to data useful for facilitating settlement of insurance and/or subrogation claims. Such information may include, in some embodiments, one or more of: claim information (e.g., costs paid for one or more past medical injury claims, a claim number, a name of an insured, a name of an injured worker or other claimant), subrogation information (e.g., information about a third party recovery case) and jurisdiction information (e.g., information about a statutory future credit available in a state, information about a percentage of claimed benefits owed until a future credit is exhausted). In some embodiments claim information and/or subrogation information may include and/or be based on one or more types of jurisdiction information.

According to some embodiments, any or all of such data may be stored by or provided via one or more optional data provider devices 106 of system 100. A data provider device 106 may comprise, for example, an external hard drive or flash drive connected to a server computer 102, a remote computer system of a data provider entity for storing and serving data for use in determining settlement negotiation information and scenarios, or a combination of such remote and local data devices.

A data provider entity (e.g., a party other than an owner and/or operator, etc., of the server computer 102, client computer 104, other than an end-user of the data and other than a third party defendant) may act, for example, as a vendor collecting data on behalf of the owner, a marketing firm, government agency and/or regulatory body, and/or demographic data gathering and/or processing firm.

A data provider entity may, for example, monitor jurisdictional statutes and regulations, litigation information (e.g., related to third party recovery cases), life expectancy data, demographic data and/or claim data for various purposes deemed useful by the data provider entity, including data aggregation, data mining and data analysis, and any raw data, processed data, proprietary analysis and/or metrics may be stored on and/or via the data provider device 106. In one embodiment, one or more companies and/or end users may subscribe to or otherwise purchase data (e.g., jurisdiction-specific information and/or demographics data) from a data provider entity and receive the data from the data provider entity and/or via the data provider device 106.

In some embodiments, a client computer 104, such as a computer workstation or terminal of a claim professional of an insurance company, is used to execute a settlement negotiation application, stored locally on the client computer 104, that accesses information stored on, or provided via, the server computer 102. In another embodiment, the server computer 102 may store some or all of the program instructions for determining information for settlement negotiations and/or generating one or more negotiation scenarios, and the client computer 104 may execute the application remotely via the network 160 and/or download from the server computer 102 (e.g., a web server) some or all of the program code for executing one or more of the various functions described in this disclosure.

In one embodiment, a server computer may not be necessary or desirable. For example, some embodiments described in this disclosure may be practiced on one or more devices without a central authority. In such an embodiment, any functions described herein as performed by a server computer and/or data described as stored on a server computer may instead be performed by or stored on one or more such devices. Additional ways of distributing information and program instructions among one or more client computers 104 and/or server computers 102 will be readily understood by one skilled in the art upon contemplation of the present disclosure.

FIG. 1B depicts a block diagram of another example system 150 according to some embodiments. The system 150 may comprise one or more client computers 104 in communication with a claim management system 180 (such as may be hosted by, for example, a server computer 102) via a network 160. A global settlement system 170 is integrated into the central claim management system 180, for example, as a module or other functionality accessible through the claim management system 180. In one embodiment, information about a particular claim and/or subrogation interest stored by the claim management system 180 may be provided advantageously to the global settlement system 170. For example, stored information about a claim (e.g., a claim number), an injured claimant (e.g., age, state of residence), an insured (e.g., an employer of an injured worker) and/or a third party defendant may be accessible by the global settlement system 170 without requiring manual input (e.g., by a claim professional, by a subrogation professional). As discussed above with respect to system 100 of FIG. 1A, in some embodiments one or more data provider devices 106 may store information (e.g., jurisdiction information, cost information) that may be useful in determining one or more settlement negotiation scenarios.

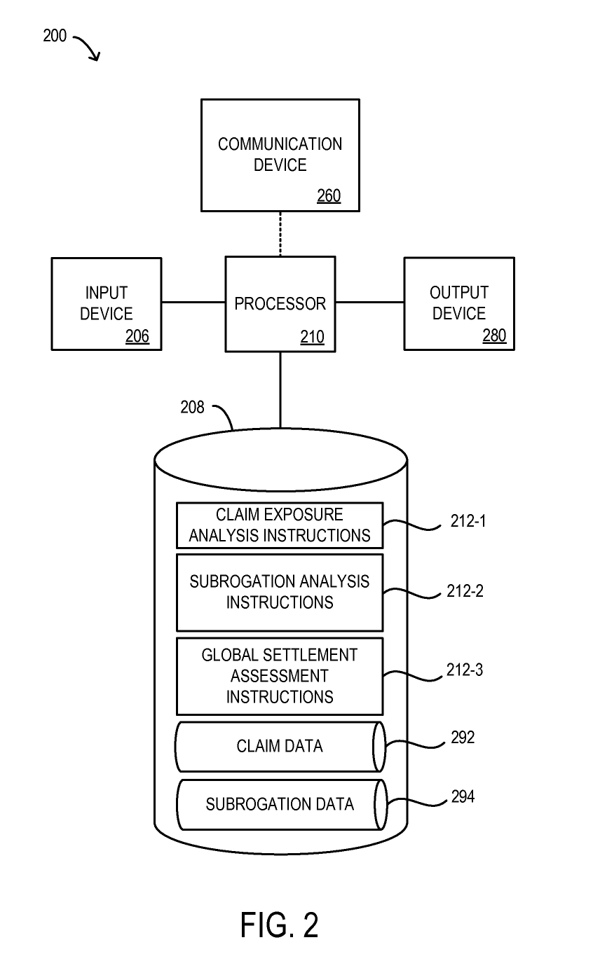

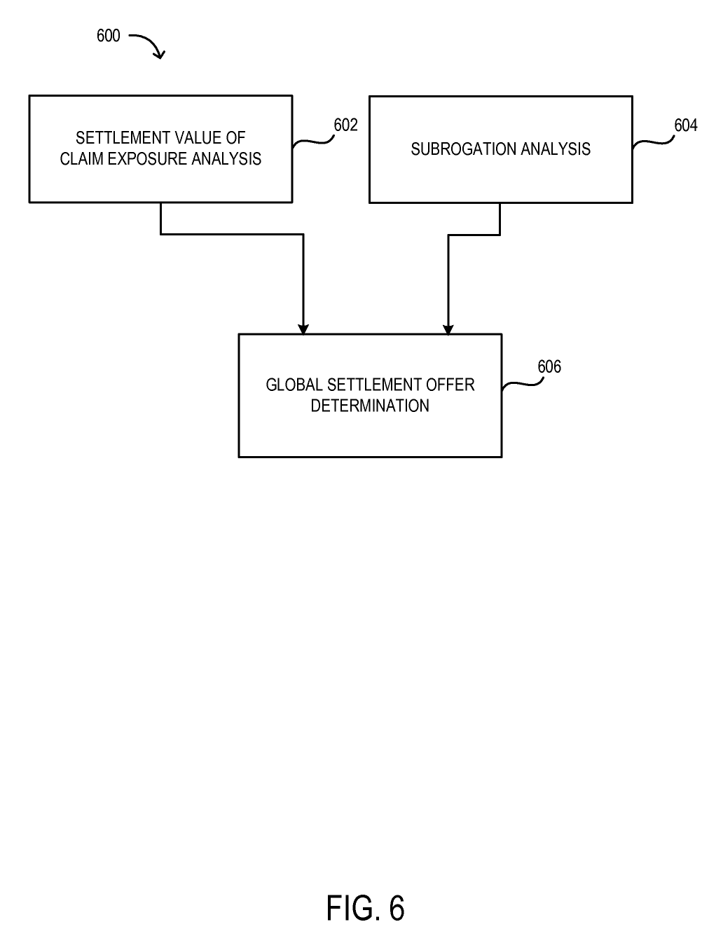

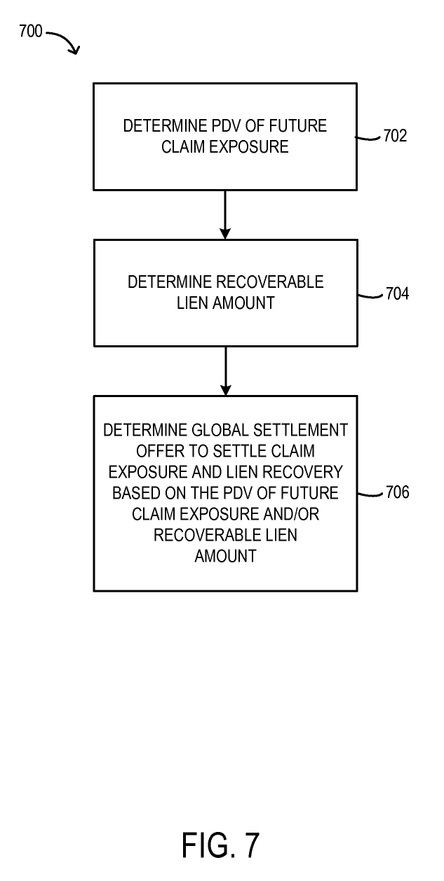

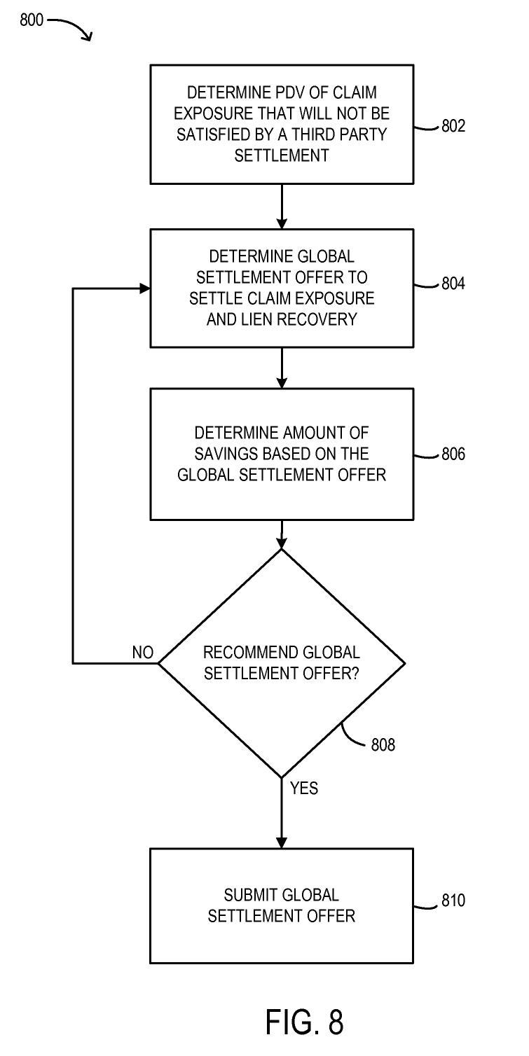

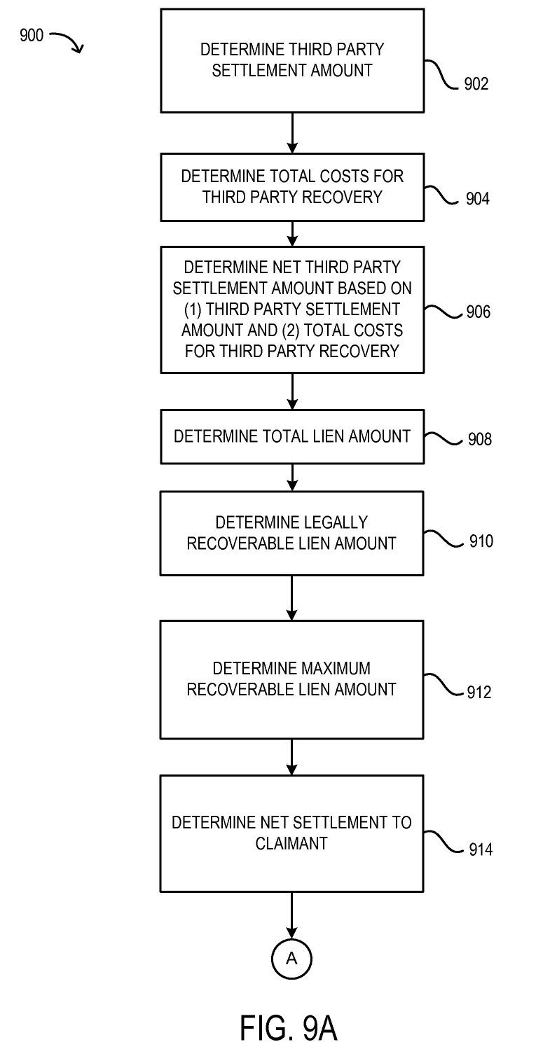

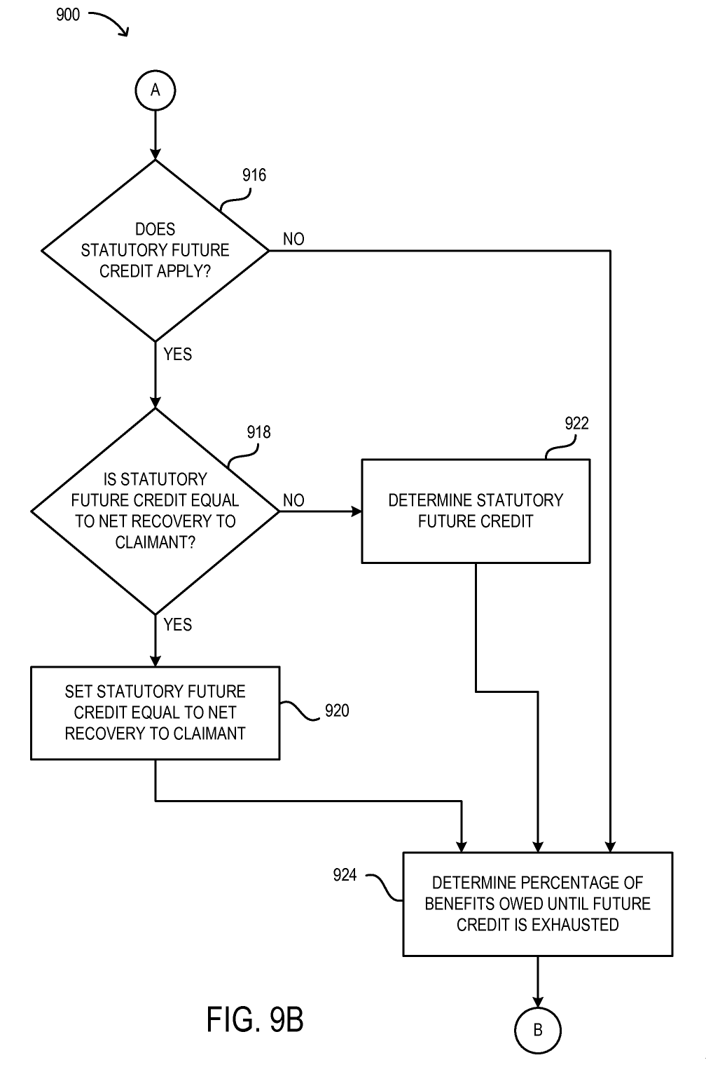

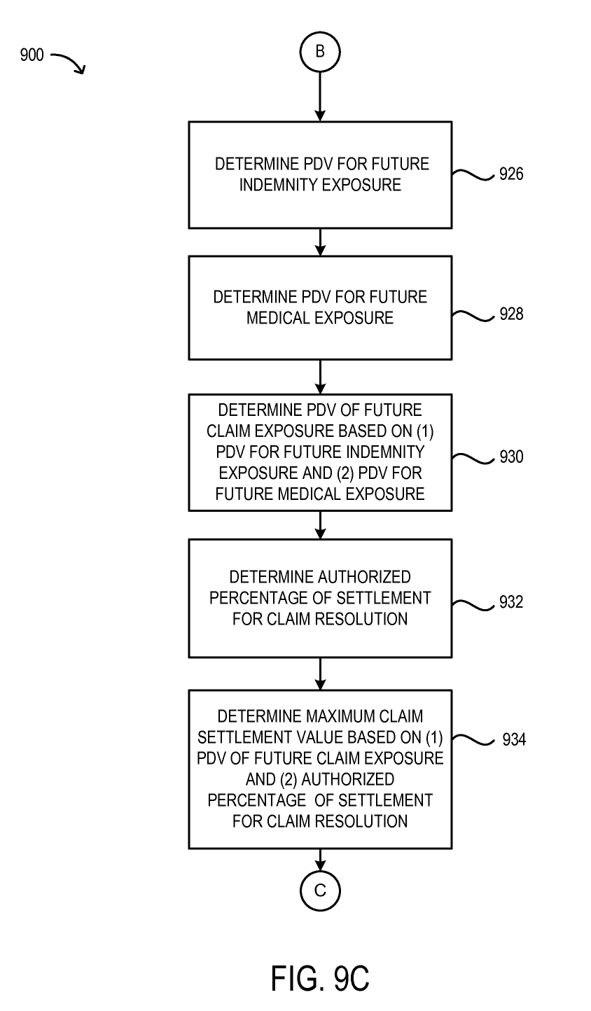

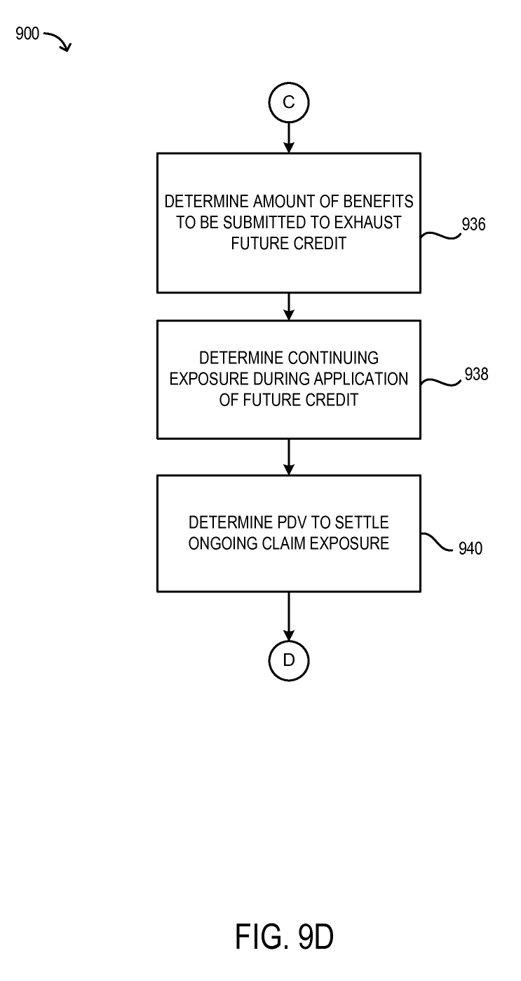

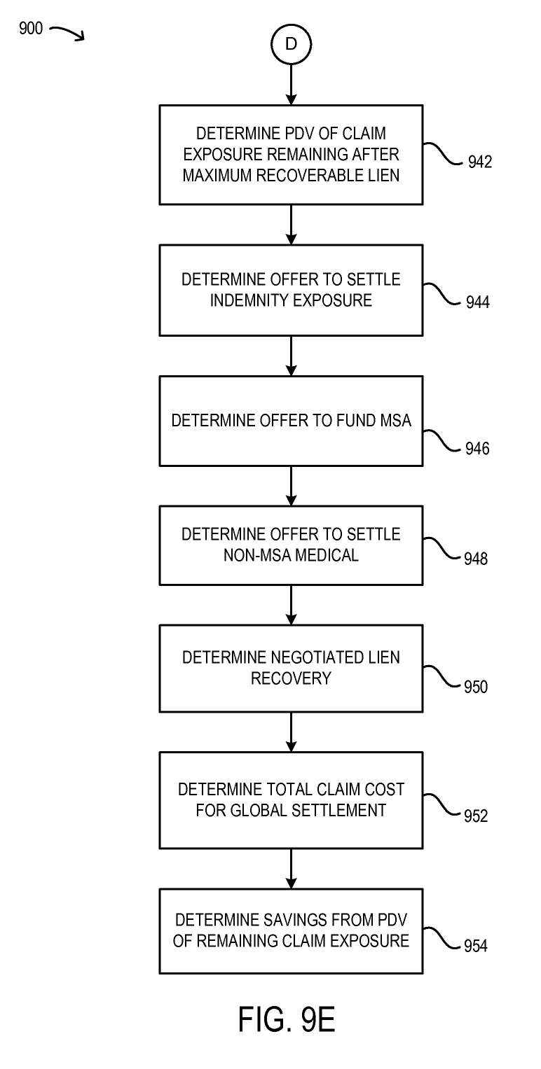

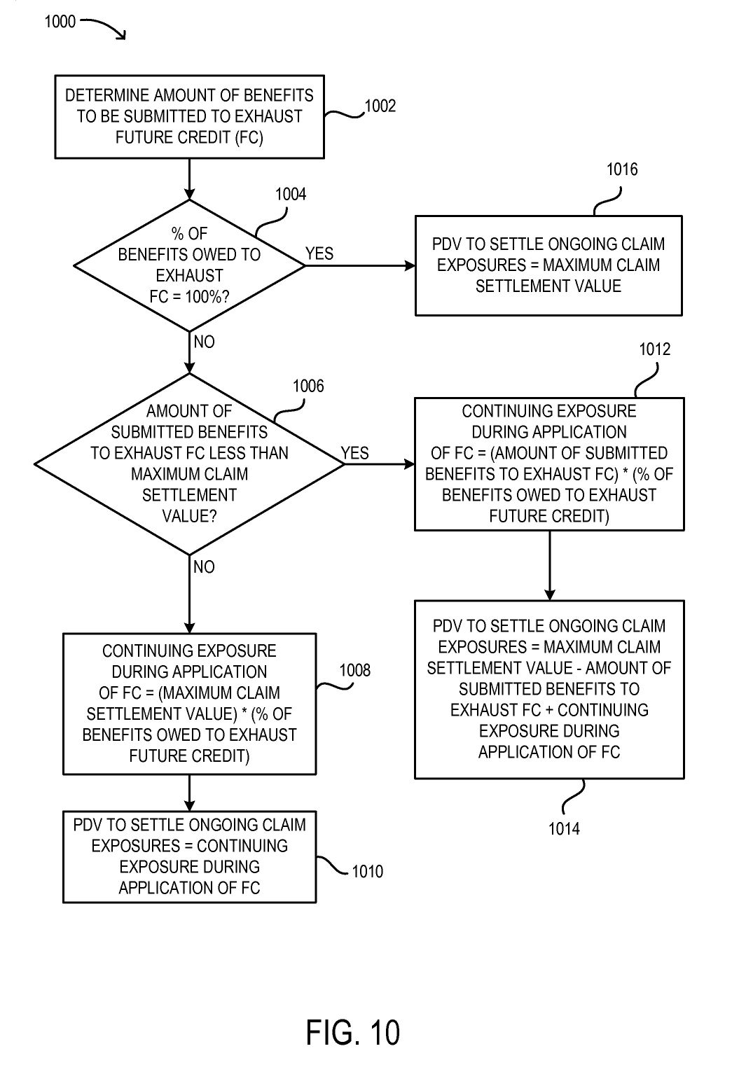

Turning to FIG. 2, a block diagram of an apparatus 200 according to some embodiments is shown. In some embodiments, the apparatus 200 may be similar in configuration and/or functionality to any of the client computers 104, server computers 102, data provider devices 106 and/or claim management system 180 of FIG. 1A and/or FIG. 1B. The apparatus 200 may, for example, execute, process, facilitate, and/or otherwise be associated with any of the processes 600, 700, 800, 900, 1000 described in conjunction with FIG. 6, FIG. 7, FIG. 8, FIG. 9A, FIG. 9B, FIG. 9C, FIG. 9D, FIG. 9E and FIG. 10 herein.

In some embodiments, the apparatus 200 may comprise an input device 206, a memory device 208, a processor 210, a communication device 260, and/or an output device 280. Fewer or more components and/or various configurations of the components 206, 208, 210, 260, 280 may be included in the apparatus 200 without deviating from the scope of embodiments described herein.

According to some embodiments, the processor 210 may be or include any type, quantity, and/or configuration of processor that is or becomes known. The processor 210 may comprise, for example, an Intel® IXP 2800 network processor or an Intel® XEON™ Processor coupled with an Intel® E7501 chipset. In some embodiments, the processor 210 may comprise multiple inter-connected processors, microprocessors, and/or micro-engines. According to some embodiments, the processor 210 (and/or the apparatus 200 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 900 comprises a server such as a blade server, necessary power may be supplied via a standard AC outlet, power strip, surge protector, and/or Uninterruptible Power Supply (UPS) device.

In some embodiments, the input device 206 and/or the output device 280 are communicatively coupled to the processor 210 (e.g., via wired and/or wireless connections and/or pathways) and they may generally comprise any types or configurations of input and output components and/or devices that are or become known, respectively.

The input device 206 may comprise, for example, a keyboard that allows an operator of the apparatus 200 to interface with the apparatus 200. In one example, a subrogation professional and/or claim professional may interface with the apparatus to develop one or more negotiation scenarios for global settlement of a compensation claim and a subrogation interest of an insurance carrier. In some embodiments, the input device 206 may comprise a sensor configured to provide information such as encoded claim, claimant or third party litigation information to the apparatus 200 and/or the processor 210.

The output device 280 may, according to some embodiments, comprise a display screen and/or other practicable output component and/or device. The output device 280 may, for example, indicate, display or otherwise provide various types of information, including information associated with a global settlement (e.g., claim information, subrogation information, jurisdiction information, negotiation scenarios), to an insurance claim professional and/or subrogation professional (e.g., via a computer workstation). According to some embodiments, the input device 206 and/or the output device 280 may comprise and/or be embodied in a single device such as a touch-screen monitor.

In some embodiments, the communication device 260 may comprise any type or configuration of communication device that is or becomes known or practicable. The communication device 260 may, for example, comprise a network interface controller (NIC), a telephonic device, a cellular network device, a router, a hub, a modem and/or a communications port or cable. In some embodiments, the communication device 260 may be coupled to provide data to a telecommunications device. The communication device 260 may, for example, comprise a cellular telephone network transmission device that sends signals (e.g., claim information, subrogation information, negotiation scenario parameters) to a server in communication with a plurality of handheld, mobile and/or telephone devices. According to some embodiments, the communication device 260 may also or alternatively be coupled to the processor 210. In some embodiments, the communication device 260 may comprise an IR, RF, Bluetooth™, and/or Wi-Fi® network device coupled to facilitate communications between the processor 210 and another device (such as one or more client computers, server computers, central controllers and/or data provider devices).

The memory device 208 may comprise any appropriate information storage device that is or becomes known or available, including, but not limited to, units and/or combinations of magnetic storage devices (e.g., a hard disk drive), optical storage devices, and/or semiconductor memory devices such as Random Access Memory (RAM) devices, Read Only Memory (ROM) devices, Single Data Rate Random Access Memory (SDR-RAM), Double Data Rate Random Access Memory (DDR-RAM), and/or Programmable Read Only Memory (PROM).

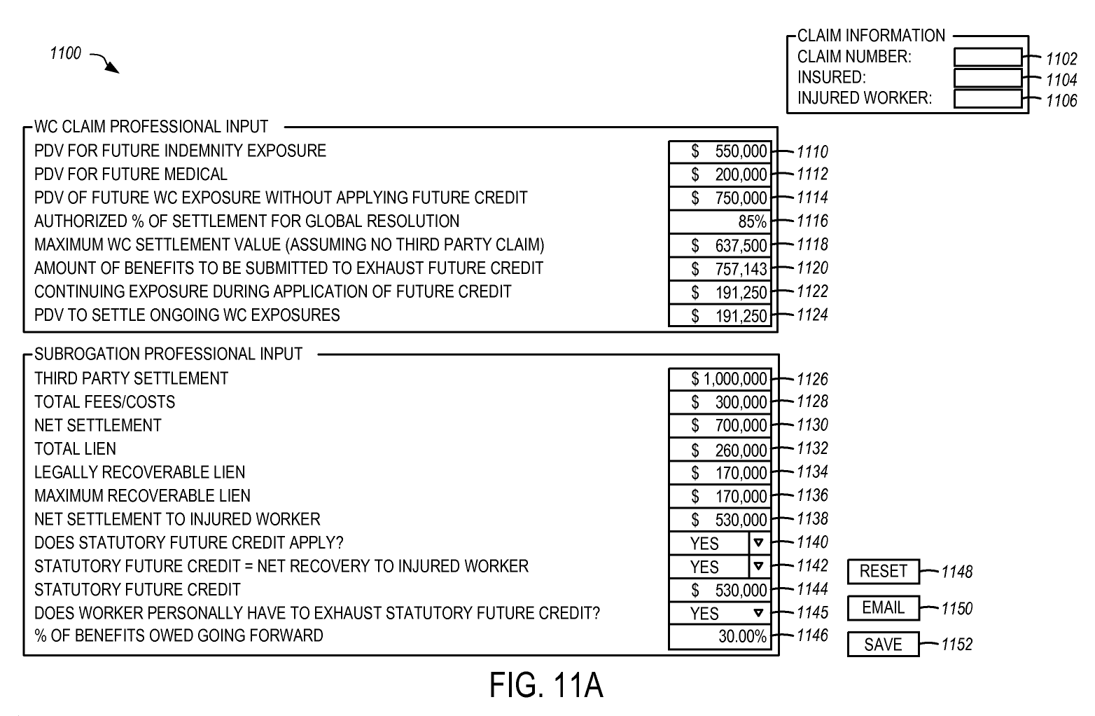

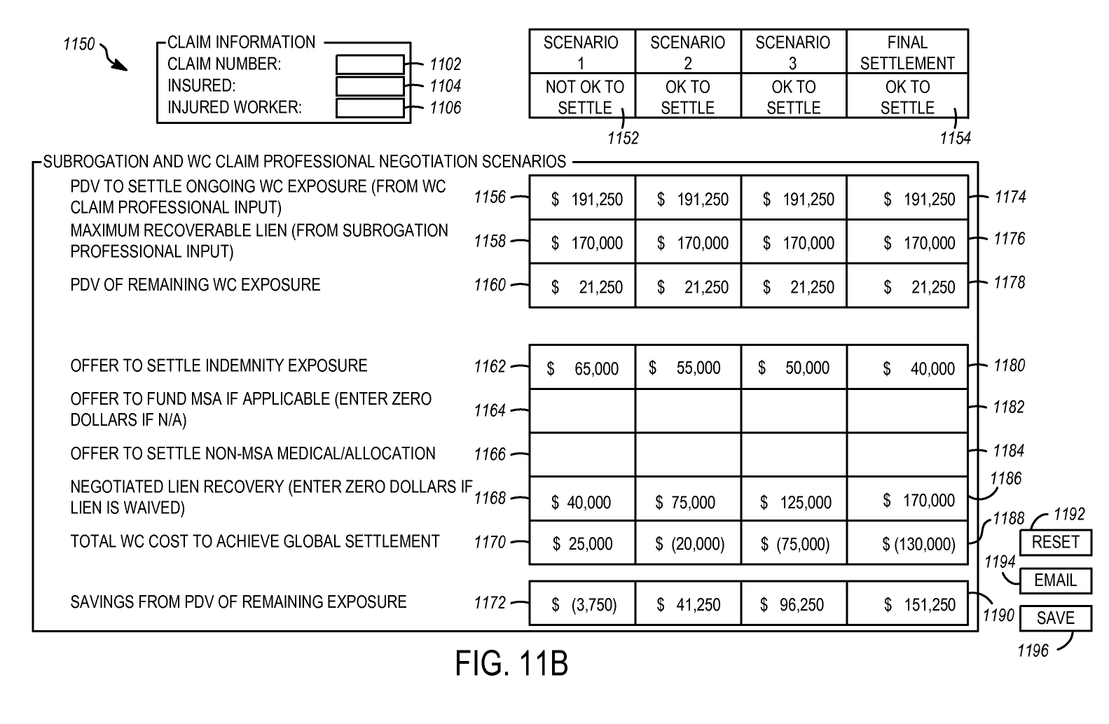

The memory device 208 may, according to some embodiments, store one or more of claim exposure analysis instructions 212-1, subrogation analysis instructions 212-2, global settlement assessment instructions 212-3, claim data 292 and/or subrogation data 294. In some embodiments, the claim exposure analysis instructions 212-1, subrogation analysis instructions 212-2 and/or global settlement assessment instructions 212-3 may be utilized by the processor 210 to provide output information via the output device 280 and/or the communication device 260 (e.g., via the user interfaces 1100 and/or 1150 of FIG. 11A and FIG. 11B, respectively).

According to some embodiments, as described herein, claim exposure analysis instructions 212-1 may be operable to cause the processor 210 to determine and/or process information related to a claim (e.g., a workers' compensation claim). Claim data 292 and/or subrogation data 294 may be received, for example, via the input device 206 and/or the communication device 260 and may be analyzed or otherwise processed by the processor 210 in accordance with one or more of the instructions of claim exposure analysis instructions 212-1 (e.g., in accordance with the method 1000 of FIG. 10). The claim exposure analysis instructions 212-1 may, in some embodiments, utilize information associated with a particular jurisdiction, such as a state's statutory future credit and/or an amount or percentage of benefits owed during application of future credit.

According to some embodiments, the subrogation analysis instructions 212-2 may be operable to cause the processor 210 to determine and/or process information corresponding to a subrogation interest (e.g., of a carrier) in a third party recovery, as described herein. Claim data 292 and/or subrogation data 294 may be received, for example, via the input device 206 and/or the communication device 260 and may be analyzed or otherwise processed by the processor 210 in accordance with one or more of the instructions of subrogation analysis instructions 212-2 (e.g., in accordance with the method 900 of FIGS. 9A-9E). The subrogation analysis instructions 212-2 may, in some embodiments, utilize information associated with a particular jurisdiction, such as a statutory limit on a recoverable lien.

The apparatus 200 may function, in some embodiments, as a computer terminal and/or server of an insurance carrier that is utilized to process insurance claims and/or assess the carrier's subrogation interests. In some embodiments, the apparatus 200 may comprise a web server and/or other portal (e.g., an interactive voice response unit (IVRU)) that provides claim data 292 and/or subrogation data 294 to users, consumers and/or corporations.

Any or all of the exemplary instructions and data types described herein and other practicable types of data may be stored in any number, type, and/or configuration of memory devices that is or becomes known. The memory device 208 may, for example, comprise one or more data tables or files, databases, table spaces, registers, and/or other storage structures. In some embodiments, multiple databases and/or storage structures (and/or multiple memory devices 208) may be utilized to store information associated with the apparatus 200. According to some embodiments, the memory device 208 may be incorporated into and/or otherwise coupled to the apparatus 200 (e.g., as shown) or may simply be accessible to the apparatus 200 (e.g., externally located and/or situated).

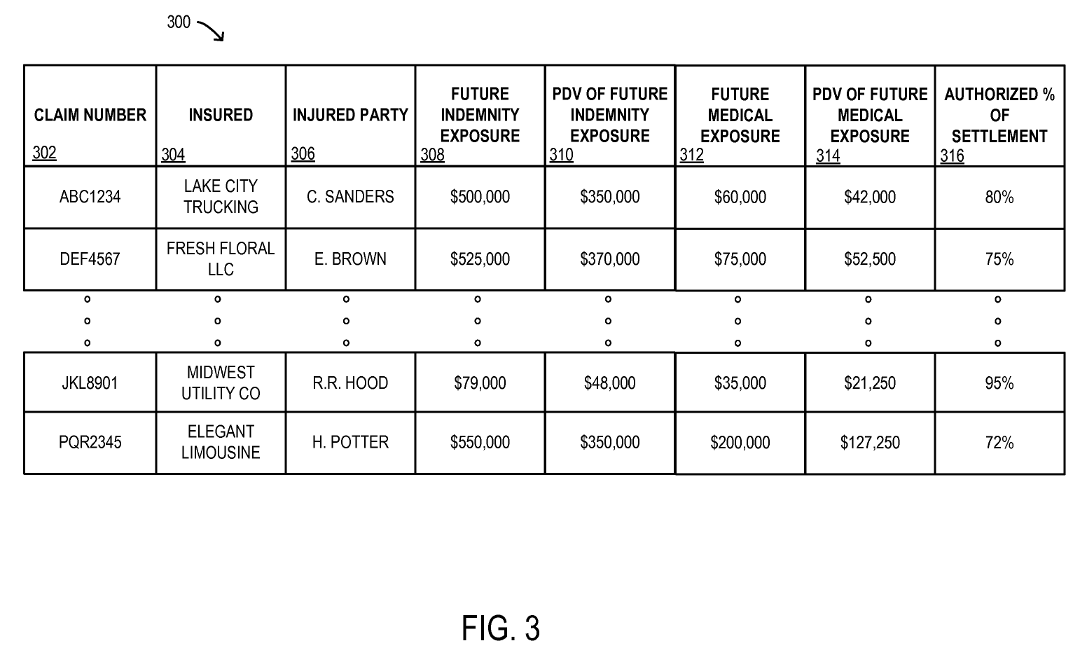

Referring to FIG. 3, a schematic illustration of an exemplary data structure 300 according to some embodiments is shown. In some embodiments, the exemplary data structure 300 may comprise a tabular representation illustrating an embodiment of the claim data 292. The exemplary data structure 300 that is representative of the claim data 292 includes a number of example records or entries, each of which defines information associated with a particular claim. Those skilled in the art will understand that the claim data 292 may include any number of entries. The exemplary data structure 300 of the claim data 292 also defines fields for each of the entries or records, including: (i) a claim number 302, (ii) an insured 304, (iii) an injured party 306, (iv) a future indemnity exposure 308, (v) a PDV of future indemnity exposure 310, (vi) a future medical exposure 312, (vii) a PDV of future medical exposure 314 and (viii) an authorized % of settlement 316.

In one or more embodiments, the claim number 302 allows for entry and storage of a claim number or other identifier that uniquely identifies a particular claim (e.g., a workers' compensation claim). In one or more embodiments, the insured 304 allows for entry and storage of an identifier, such as a name or other identifier, which identifies an insured (e.g., an employer, a claimant, a holder of an indemnity policy) associated with the corresponding claim.

In one or more embodiments, the injured party 306 allows for entry and storage of an identifier that uniquely identifies an injured party associated with the corresponding claim (e.g., an injured worker filing a claim under an employer's workers' compensation system). Although example data structure 300 provides for a claimant who is an injured party, it will be readily understood in light of the present disclosure that other additional or alternative types of claimants may be provided for in various embodiments.

In one or more embodiments, the future indemnity exposure 308 allows for entry and storage of an amount of future indemnity exposure associated with the corresponding claim. As described herein, the future indemnity exposure may be used in determining, among other things, a PDV of the future indemnity exposure and/or a maximum indemnity settlement value. In one or more embodiments, the PDV of future indemnity exposure 310 allows for entry and storage of an amount that is a present day value of the future indemnity exposure associated with the claim (e.g., as may be stored in future indemnity exposure 308).

In one or more embodiments, the future medical exposure 312 allows for entry and storage of an amount of future medical exposure associated with the corresponding claim. As described herein, the future medical exposure may be used in determining, among other things, a PDV of the future medical exposure and/or an amount of future exposure without applying for future credit. In one or more embodiments, the PDV of future medical exposure 314 allows for entry and storage of an amount that is a present day value of the future medical exposure associated with the claim (e.g., as may be stored in future medical exposure 312).

In one or more embodiments, the authorized % of settlement 316 allows for entry and storage of a representation of an authorized % of settlement associated with the corresponding claim. In one example, authorization is granted to settle for up to 80% of the present day value of a total claim exposure for claim number ABC1234, and an indication of the authorized percentage is stored in the claim data 292 in association with the claim.

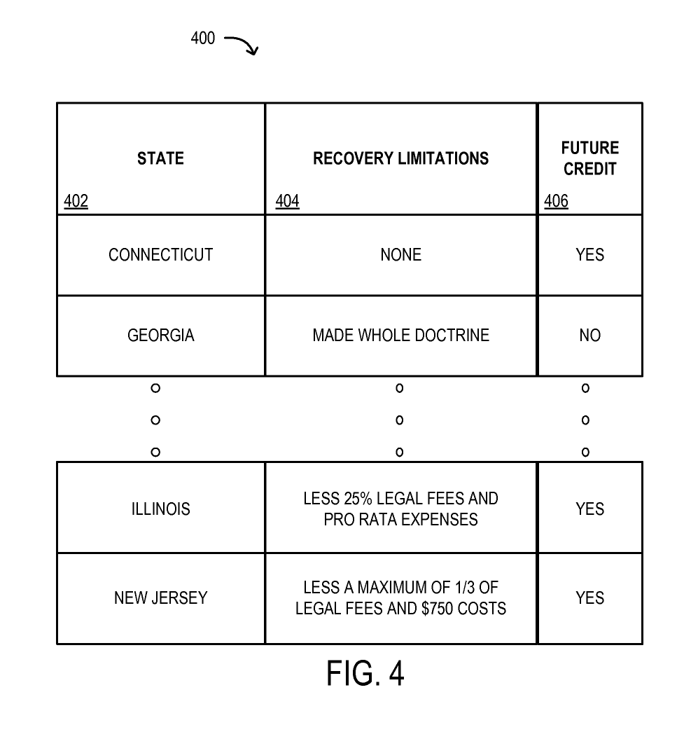

Referring to FIG. 4, a schematic illustration of an exemplary data structure 400 according to some embodiments is shown. In some embodiments, the exemplary data structure 400 may comprise a tabular representation illustrating an embodiment of jurisdiction information. In some embodiments the jurisdiction information may be stored with or in association with the subrogation data 294 and/or claim data 292 (e.g., in memory 208). The exemplary data structure 400 that is representative of the jurisdiction information includes a number of example records or entries, each of which defines information corresponding to a particular state. Those skilled in the art will understand that the jurisdiction information may include any number of entries. The exemplary data structure 400 also defines fields for each of the entries or records, including: (i) a state 402, (ii) one or more recovery limitations 404, and (iii) a future credit 406.

In one or more embodiments, the state 402 allows for entry and storage of an identifier that identifies a state (or province). Although the identifiers provided in the example data structure 400 are text descriptions, it will be understood that such identifiers could be any alphanumeric or other type of identifier that uniquely identifies a particular jurisdiction of interest (e.g., Arkansas). Although the example data structure 400 includes records directed to states, it will be understood that any type of jurisdiction (e.g., city, county, ZIP code area, country) may be provided for as practicable for a desired implementation.

In one or more embodiments, the recovery limitations 404 allows for entry and storage of an indication of one or more limitations on subrogation rights in third party recovery, as applicable in the corresponding jurisdiction. For example, exemplary data structure 400 indicates that the “MADE WHOLE DOCTRINE” is a controlling limitation on third party recovery in Georgia, while no recovery limitations are provided for in Connecticut. As discussed herein, a jurisdiction's limitation on recovery may be used in determining a legally recoverable and/or maximum allowable lien (e.g., of an insurance carrier) with respect to a global settlement.

In one or more embodiments, the future credit 406 allows for entry and storage of an indication of whether, in the corresponding jurisdiction, a carrier can receive a credit toward future compensation benefits it owes a claimant and/or an indication of whether any percentage of benefits is owed by a carrier to a claimant (e.g., even where a future credit is available and not yet exhausted). In some embodiments, as discussed herein, information about whether a future credit is available (e.g., for a workers' compensation case) may be used in determining an amount of benefits to be submitted to exhaust a future credit and/or determining an amount suggested to settle ongoing claim exposure (e.g., in accordance with the method 1000 of FIG. 10).

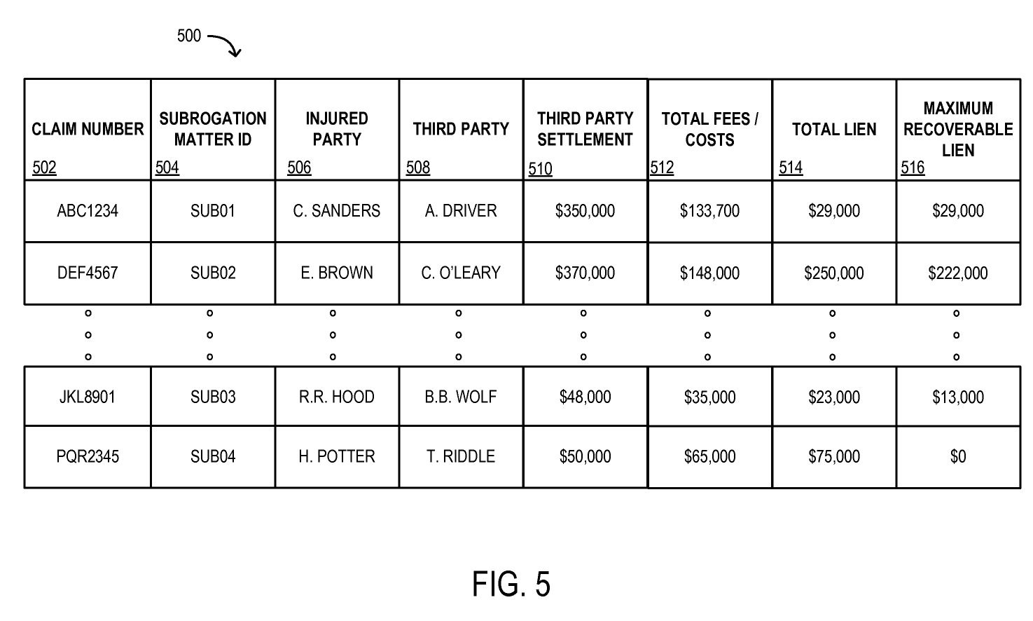

Referring to FIG. 5, a schematic illustration of an exemplary data structure 500 according to some embodiments is shown. In some embodiments, the exemplary data structure 500 may comprise a tabular representation illustrating an embodiment of the subrogation data 294. The exemplary data structure 500 that is representative of the subrogation data 294 includes a number of example records or entries, each of which defines information corresponding to a subrogation case or matter. Those skilled in the art will understand that the subrogation data 294 may include any number of entries. The exemplary data structure 500 of the subrogation data 294 also defines fields for each of the entries or records, including: (i) a claim number 502, (ii) a subrogation matter ID 504, (iii) an injured party 506, (iv) a third party 508, (v) a third party settlement 510, (vi) a total fees/costs 512, (vii) a total lien 514 and (viii) a maximum recoverable lien 516.

In one or more embodiments, the claim number 502 allows for entry and storage of a claim number or other identifier that uniquely identifies a particular claim that is associated with a corresponding subrogation interest (e.g., of a carrier) in a third party settlement or other third party recovery. In one example, the claim may be a workers' compensation claim associated with an injured worker, and the injured worker is also seeking a recovery from a third party defendant, based at least in part on the injury to the worker.

In one or more embodiments, the subrogation matter ID 504 allows for entry and storage of an identifier that uniquely identifies a subrogation interest or matter that is associated with the corresponding claim. For example, an insurance carrier may have paid out benefits to an injured worker for a workers' compensation claim, and the injured worker may also be receiving third party recovery from a third party defendant (e.g., for causing an accident that injured the worker). The insurance carrier may have a subrogation interest in the third party recovery and may identify and/or track its subrogation interest using a subrogation matter ID.

In one or more embodiments, the injured party 506 allows for entry and storage of an identifier that identifies an injured party associated with the corresponding claim.

In one or more embodiments, the third party 508 allows for entry and storage of an identifier that identifies a third party from whom a claimant is seeking recovery (e.g., in a litigation, negotiation and/or settlement proceeding). In one example, the third party is an individual, business or other entity accused of causing, at least in part, the injury to the injured party identified in injured party 506.

In one or more embodiments, the third party settlement 510 allows for entry and storage of an indication of a value (e.g., a monetary amount) that a third party (e.g., a third party defendant) will provide (or has indicated it will provide) to a plaintiff or claimant (e.g., an injured worker) to settle an action or claim by the plaintiff or claimant against the third party defendant. In one example, a settlement amount is offered by a third party defendant as part of a negotiated settlement between the third party defendant and a plaintiff in a lawsuit against the third party defendant (e.g., a negligence lawsuit). In another example, the third party settlement amount is offered by a third party to a claimant prior to or without initiation of any legal or formal action by the claimant against the third party. In some embodiments, a third party settlement value may be used in determining one or more negotiation scenarios. In some embodiments, a third party settlement may be used in determining one or more of a net third party settlement, a total lien, a legally recoverable lien and a maximum recoverable lien.

In one or more embodiments, the total fees/costs 512 allows for entry and storage of an indication of a total amount of fees and/or costs associated with a third party settlement. For example, such an amount may include a plaintiffs attorneys' fees incurred by a claimant in negotiating with and/or bringing suit against a third party defendant.

In one or more embodiments, the total lien 514 allows for entry and storage of an indication of an amount of a total lien or other subrogation interest of a carrier associated with a claim. In one embodiment the total lien amount comprises a value of the subrogable benefits paid to a claimant. For example, the total lien 514 may include a monetary value of the benefits paid to date to an injured worker on a workers' compensation claim (e.g., as may be identified by claim number 502 in a corresponding record).

In one or more embodiments, the maximum recoverable lien 516 allows for entry and storage of an indication of an amount or value representing a maximum recoverable lien of a carrier with respect to the corresponding claim. In one embodiment the maximum recoverable lien amount is based on a legally recoverable lien amount. For example, as discussed with respect to recovery limitations 404 of exemplary data structure 400, some states provide for limitations on the lien amount a carrier may recover. In some embodiments, the maximum recoverable lien may be based on the availability of funds from the third party. For example, although a carrier may be entitled legally to recover a particular lien amount, the coverage limits on an insurance policy of the third party may limit the amount of funds the third party has available to satisfy any settlement or judgment amount, and therefore may limit the amount the claimant and/or insurance carrier actually will be able to recover from the third party.

Referring now to FIG. 6, a flow diagram of a method 600 according to some embodiments is shown. The method 600 may, for example, be performed by or on behalf of an insurance carrier or other user. For purposes of brevity, the method 600 will be described herein as being performed by a computer (e.g., a client computer operated by one or more claim and/or subrogation professionals) on behalf of an insurance company. It should be noted that although some of the steps of method 600 may be described herein as being performed by a client computer while other steps are described herein as being performed by another computing device, any and all of the steps may be performed by a single computing device which may be a client computer, server computer, data provider device or another computing device. Further, any steps described herein as being performed by a particular computing device may be performed by a human or another computing device as appropriate.

According to some embodiments, the method 600 may comprise analysis of settlement value of claim exposure at 602. Such analysis may comprise one or more of: determining future indemnity exposure, determining future medical exposure, determining future claim exposure with and/or without future credit, determining a statutory future credit, determining a percentage of benefits owed until future credit is exhausted, determining an authorize % of settlement for global settlement or resolution, determining a maximum claim exposure settlement value, determining an amount of benefits to be submitted to exhaust future credit, determining continuing exposure during application of future credit, determining an amount to settle ongoing claim exposures and/or determining a PDV of any such exposure or other values or amounts. In one embodiment, claim exposure settlement value analysis results in a determination of a PDV of an amount to settle ongoing claim exposure (e.g., for a workers' compensation claim).

In other embodiments, the claim exposure settlement value analysis does not necessarily rely on any PDV considerations. For example, it may be considered inefficient to determine the PDV of indemnity exposure and/or medical exposure where the period of time over which the benefits would be paid is fairly short (e.g., where the future value of the exposure would closely approximate the PDV of the exposure) or the monetary value of the benefits is smaller. In one embodiment, determining a settlement value of ongoing claim exposure may be based on an authorized settlement value (assuming no third party claim) determined for a smaller value case (e.g., by a claim professional, or by a program accessing and retrieving the value from a database of claim data) without necessarily considering or computing the present day value of the authorized settlement value or of any future indemnity or medical component of the claim exposure

According to some embodiments, the method 600 may comprise analysis of a subrogation matter or opportunity, at 604. Such analysis may comprise one or more of: determining a statutory future credit, determining a percentage of benefits owed until future credit is exhausted, determining a total lien (e.g., of a carrier), determining a legally recoverable lien, determining a maximum recoverable lien, determining a third party settlement amount, determining total costs/fees for third party recovery, determining whether a future credit applies in the relevant jurisdiction and/or determining an amount of a future credit (if available).

According to some embodiments, the method 600 may comprise a global settlement offer determination, at 606. In one or more embodiments, determining at least one global settlement offer may comprise determining the at least one global settlement offer based on information derived from the settlement value of claim exposure analysis 602 and on information derived from the subrogation analysis 604. In one example, determining a global settlement offer may comprise determining at least one negotiation scenario based on a PDV to settle ongoing workers' compensation exposure, derived in 602, and a maximum recoverable lien, determined in 604.

Various examples of the analysis and determinations outlined in the method 600 are described in further detail with respect to methods 700, 800, 900 and 1000 of FIG. 7, FIG. 8, FIGS. 9A-9E and FIG. 10, respectively, and example interfaces 1100 and 1150 of FIG. 11A and FIG. 11B, respectively.

Referring now to FIG. 7, a flow diagram of a method 700 according to some embodiments is shown. The method 700 may, for example, be performed by or on behalf of an insurance carrier or other user. For purposes of brevity, the method 700 will be described herein as being performed by a computer (e.g., a client computer operated by one or more claim and/or subrogation professionals) on behalf of an insurance company. It should be noted that although some of the steps of method 700 may be described herein as being performed by a client computer while other steps are described herein as being performed by another computing device, any and all of the steps may be performed by a single computing device which may be a client computer, server computer, data provider device or another computing device. Further, any steps described herein as being performed by a particular computing device may be performed by a human or another computing device as appropriate.

According to some embodiments, the method 700 may comprise determining a PDV of future claim exposure, at 702. Determining the PDV of future claim exposure may comprise one or more of: determining total projected future claim exposure (e.g., future indemnity and/or future medical exposure associated with a workers' compensation claim), determining future indemnity exposure, determining future medical exposure, determining future claim exposure with and/or without future credit, determining a future credit (e.g., a statutory future credit) and/or determining a PDV of any such exposure value or amount (e.g., by applying a PDV discount or other factor).

In one example of determining the PDV of future claim exposure, a claim professional (e.g., specializing in workers' compensation claims) enters a future indemnity exposure and/or future medical exposure (and/or PDV of such exposure(s)) via a user interface (e.g., by typing the exposure amount(s) in a text box or other field). In another example, a global settlement system application sends a request (e.g., including information identifying a claim, such as a claim number) to a computer (e.g., a server computer) for a future claim exposure (and/or PDV of such exposure) and the computer returns the requested information (e.g., by accessing it in claim data 292 and transmitting it to the global settlement system). In some embodiments, determining the PDV of future claim exposure may comprise determining the future claim exposure and calculating, looking up or otherwise determining the PDV of the determined future claim exposure.

In one or more embodiments, future indemnity exposure is determined (e.g., by a claim professional) based on the facts of the case and the particular state or other jurisdiction applicable to the case. In many cases, state law will dictate a compensation rate, a duration and a formula for the indemnity benefits (e.g., for a workers' compensation claim). To determine ongoing indemnity claim exposure, the client computer and/or claim professional may apply a normal life expectancy to an applicable annual indemnity compensation rate. Determination of life expectancy based on various factors, including gender, is well known in the actuarial and insurance industries.

To determine PDV for an indemnity exposure, the client computer and/or claim professional may refer to or access information on compound interest (e.g., a presumed 7.5% interest rate per annum) and, based on the life expectancy of the claimant, determine a PDV of future claim exposure for the particular claim. In some embodiments, determining the PDV may comprise determining a PDV factor or coefficient that is based on one or more of an age of the claimant, a gender of the claimant, a life expectancy of the claimant, a benefits period (e.g., a year of benefits), an annual interest rate and/or an annual escalation rate. An escalation rate (e.g., 0.0%, 3.0%), in some embodiments, is applicable in certain jurisdictions that allow for periodic cost of living adjustments. Determining the PDV of lifetime indemnity exposure for a claim may comprise multiplying a determined PDV factor by the amount of benefits payable for a benefits period (e.g., an annual compensation payment rate). In one example, a PDV of lifetime indemnity exposure=PDV Factor (Age, Gender, Escalation Rate)*Annual Benefit.

In one or more embodiments, determining the PDV factor may comprise creating, maintaining and/or accessing a table or other data structure storing or otherwise including respective PDV factors associated with a claimant's current age and/or gender. As noted above, the PDV factors may take into account various factors such as the assumed interest rate, life expectancy, annual benefit period and/or escalation rate, and may accordingly imbed compound interest impact in a life expectancy determination. As a result multiplying an annual benefit by such a PDV factor allows conveniently for taking into account both life expectancy considerations and a present day value discount. For example, for an assumed 7.5% interest rate and 0.0% escalation rate (no escalation), the corresponding PDV factors may be represented in a data structure such as:

| | Total | | |
|---|---|---|---|
| Age | Population | Male | Female |
| 49 | 11.71 | 11.41 | 11.98 |
| 50 | 11.60 | 11.29 | 11.88 |
| 51 | 11.48 | 11.17 | 11.77 |

In one example using the above exemplary PDV factors, to determine the PDV for lifetime indemnity benefits paid annually at $10,400, with no escalation, for a 50 year-old injured male worker, a client computer and/or claim professional would determine the corresponding PDV factor based on the claim information. In this example, the applicable PDV factor for lifetime indemnity exposure would be 11.29 for a 50 year-old male worker. Multiplying the annual compensation rate of $10,400 by the PDV factor of 11.29 yields a PDV of the lifetime benefit of (11.29)*($10,400)=$117,416.

In some embodiments, payment of indemnity may be for a limited duration less than an expected lifetime of a claimant. For example, temporary total disability (TTD) and/or permanent total disability (PTD) benefits may be capped by statute, fixed permanent partial disability (PPD) awards may have to be paid in weekly increments, etc. In such embodiments, determining the PDV factor may comprise creating, maintaining and/or accessing a table or other data structure storing or otherwise including respective PDV factors associated with a number of time periods for which benefits are to be paid out. Such PDV factors may take into account various factors such as the assumed interest rate, benefit period and/or escalation rate, and may accordingly imbed compound interest impact over an expected period of time of ongoing exposure. For example, for an assumed 7.5% interest rate and 1.0% escalation rate, the corresponding PDV factors for determining a present value of an annuity on a per week basis may be represented in a data structure such as:

| Number | |
|---|---|
| of | PDV |
| Weeks | Factor |
| 95 | 89.73 |
| 96 | 90.62 |
| 97 | 91.51 |

In one example using the above exemplary PDV factors, to determine the PDV for 97 weeks of PPD benefits paid weekly at a rate of $100, with 1% escalation per annum, a client computer and/or claim professional would determine the corresponding PDV factor and apply it to the weekly benefit. In this example, the applicable PDV factor would be 91.51 for 97 weeks. Multiplying the weekly benefit rate of $100 by the PDV factor of 91.51 yields a PDV of the 97 weeks of benefits of (91.51)*($100)=$9,151.

It will be readily understood that, rather than utilizing predetermined factors combining PDV discounting with life expectancy or other time periods, determining PDV of future indemnity exposure may comprise, for example, determining a total indemnity exposure (e.g., based on a claimant's annual benefit and life expectancy) and then determining the present value of that total future exposure amount using well known methods for calculating present day value. In one example, the present day value (PDV) may be determined based on the expected future amount to be paid out (FV), the expected number of time periods (y) and the assumed interest rate per time period (r):

PDV=FV/(1+r)y.

According to some embodiments, future claim exposure may be determined based on future medical exposure. As with indemnity exposure, any future medical exposure may be determined (e.g., by a claim professional and/or claim management system) based on the facts of the case and the relevant jurisdiction. Alternatively, or in addition, determining future medical exposure may comprise analyzing a current treatment pattern, a medical payment history and/or a potential for a future major medical event (e.g., surgery).

To determine PDV for a future medical exposure for a particular claim, in some embodiments the client computer and/or claim professional may refer to or access information on compound interest (e.g., a presumed 7.5% interest rate per annum) and/or an expected period for which future benefits will be paid (e.g., a life expectancy of a claimant (or survivor), a fixed period of benefits). In one embodiment, the PDV may be determined (e.g., using a calculator program or other utility accessible on or otherwise via a computer workstation) using a formula or applied factor that combines compound interest impact with a life expectancy consideration. In some embodiments, determining the PDV may comprise determining the PDV based on an escalation rate, as discussed above with respect to indemnity exposure.

According to some embodiments, as discussed in this disclosure, determining a PDV of future exposure may comprise consideration of various additional and/or alternative factors.

According to some embodiments, the method 700 may comprise determining a recoverable lien amount, at 704. Determining, projecting and/or estimating a lien amount that may be recovered (e.g., by a carrier from a settlement of a claimant with a third party) may comprise one or more of: determining information about a third party with whom a claimant is settling (e.g., information about the third party's ability to provide the settlement), determining a statutory future credit, determining a percentage of benefits owed until future credit is exhausted, determining a total lien (e.g., of a carrier), determining a maximum recoverable lien, determining a legally recoverable lien, determining a third party settlement amount, determining total costs/fees for third party recovery, determining whether a future credit applies in a relevant jurisdiction and/or determining an amount of a future credit.

In one example of determining a recoverable lien amount, a subrogation professional (e.g., specializing in subrogation matters for an insurance carrier) and/or claim professional enter a third party settlement amount, fees and costs for the third party recovery, a statutory future credit, a percentage of benefits owed to a claimant going forward, a jurisdictional limit on lien recovery by the carrier, and/or a total lien of an insurance carrier via one or more user interfaces (e.g., by typing the amount(s) in a respective text box or other field). Additional and/or alternative information may be entered in some embodiments. Some examples are discussed further with respect to the example interfaces 1100 and 1150 depicted respectively in FIG. 11A and FIG. 11B.

In another example, a global settlement system application (e.g., running on or accessible via a computer workstation) sends a request for subrogation information to a computer (e.g., a server computer), the request including information identifying a claim and/or information identifying a subrogation matter. The computer receiving the request returns the requested information by accessing claim data 292 and/or subrogation data 294 and transmitting it to the global settlement system (e.g., in response to the request).

In some embodiments, determining a recoverable lien amount may comprise determining one or more limitations on the amount a carrier may recover. For example, a recoverable lien amount may, in some instances, be less than a total amount of benefits paid by a carrier to a claimant (e.g., a total lien amount) based on an applicable statutory restriction on recovery and/or one or more other limitations. In one embodiment, determining a recoverable lien amount may comprise determining a legally recoverable lien amount or other recovery limitation. For example, as discussed above with respect to jurisdiction information and to exemplary data structure 400, a state or other jurisdiction may limit the amount an insurance carrier may recover from a suit by a claimant against a third party. In another example, recovery by a carrier may be limited based on the availability of the funds and/or the ability of the third party to provide the settlement amount.

According to some embodiments, the method 700 may comprise determining at least one global settlement offer to settle (e.g., with a claimant) both claim exposure and lien recovery, based on the PDV of future claim exposure and/or the recoverable lien amount, at 706. In one or more embodiments, determining at least one global settlement offer may comprise one or more of: determining (e.g., by a claim professional, subrogation professional, carrier and/or claimant) at least one offer component of a global settlement offer, identifying or selecting at least one global settlement offer (e.g., from a plurality of determined or potential global settlement offers) to propose or submit to a claimant and/or claimant's representative, associating at least one offer component with a (new or previously determined) global settlement offer, determining at least one negotiation scenario, creating a new global settlement offer, determining a new offer component (e.g., by a carrier or its representative, by a claimant or its representative), modifying a previously determined global settlement offer and/or modifying, removing, replacing and/or adding at least one offer component of a global settlement offer.

In one or more embodiments, determining at least one global settlement offer may comprise determining the PDV of an amount to settle ongoing claim exposure (e.g., an authorized amount) based on the PDV of future claim exposure. Determining the PDV of an authorized amount to settle ongoing claim exposure may comprise one or more of: determining the future claim exposure, determining a statutory future credit, determining an amount of continuing exposure during application of a future credit (if available), determining a maximum (authorized) claim settlement value (e.g., assuming no third party recovery), determining a percentage of benefits owed until future credit is exhausted, determining an authorized % of settlement for global settlement or resolution, determining a maximum claim exposure settlement value, determining an amount to settle ongoing claim exposure and/or determining an amount of benefits to be claimed (e.g., by a claimant) to exhaust a future credit. Some examples of determining an amount to settle ongoing claim exposure are discussed further with respect to method 1000 of FIG. 10 and exemplary interfaces 1100 and 1150 of FIG. 11A and 11B, respectively.

In one or more embodiments, determining at least one global settlement offer may comprise determining the PDV of any ongoing claim exposure remaining after recovery by a carrier of any recoverable lien amount (e.g., a maximum recoverable lien). In one embodiment, the PDV of claim exposure remaining for settlement resolution may be determined by subtracting the recoverable lien amount from the PDV of an amount to settle ongoing claim exposure. For example, if the PDV to settle ongoing exposure for a workers' compensation case is $191,250 and the maximum recoverable lien is determined by a subrogation professional and/or claim professional to be $170,000, the PDV of remaining workers' compensation exposure after the recovery is $191,250−$170,000=$21,250.

Determining a global settlement offer of a carrier may comprise determining one or more of the following offer components: an offer of payment to the claimant to settle any remaining claim future indemnity and/or medical exposure (which may be referred to herein as “new cash” or “fresh cash”), an offer to contribute to a medical set aside (MSA) fund (e.g., for qualifying future medical exposure where Medicare may not allow settlement of the claim) and/or an offer to settle a lien on a third party recovery for a specified lien recovery amount. In one example, a global settlement offer from a carrier may comprise offer components including $40,000 of new cash for the claimant for future indemnity exposure, $10,000 for MSA funding and a negotiated lien recovery of $170,000 for the carrier (e.g., with respect to subrogable benefits provided to the claimant). In another example, smaller value cases may not involve MSA funds; accordingly, determining a global settlement offer may comprise determining only new money (e.g., an offer to settle all claim exposure) and/or negotiated lien recovery.

In one embodiment, an offer component may be determined or selected by not entering a value for the component and/or accepting a default value. For example, an offer component of $0 in new cash for indemnity exposure may be determined by a user's decision to accept (or not modify) a default blank or “0” value of the input box of an application interface corresponding to the new cash component.

In some embodiments, determining a global settlement offer may comprise determining a global settlement value. As used herein, “global settlement value” or “global settlement cost” may refer an amount provided by, or received by, a carrier to achieve the global settlement of both the claim exposure and lien recovery matters. In one aspect, the global settlement value reflects the carrier's cash flow upon closing the global settlement matter, which may be positive, negative or zero, depending on the terms of the offer. In one embodiment, determining the global settlement value comprises determining the value based on any new cash payments or MSA fund contributions to settle indemnity and/or medical exposure, minus any negotiated lien recovery. For example, using the figures in the preceding example, the determined global settlement offer provides to the carrier a positive, current value of $130,000=$170,000 (from third party settlement to carrier)−$40,000 (from carrier to claimant) on global settlement. In one embodiment, global settlement value may be represented as a cost, depending on the desired implementation (e.g., the positive $130,000 income of the preceding example may be represented analogously as a negative “cost” in the amount of −$130,000). Determining the global settlement value may be useful, in some embodiments, for assessing the business impact to the carrier (and/or to particular business units of the carrier) of a particular determined global settlement offer and/or determining whether to propose the global settlement offer to a claimant (or accept a global settlement offer proposed by a claimant).

In some embodiments, determining a global settlement offer may comprise determining an amount of global settlement savings. As used herein, “global settlement savings” may refer to an amount (positive, negative, or zero) that would be achieved by acceptance of the claimant of the proposed (or final) terms of the global settlement offer. In one embodiment, determining the global settlement offer may comprise determining a present day value representing a savings (or cost, depending on configuration of the particular offer) to a carrier resulting from global settlement, based on a determined PDV of claim exposure remaining after any recovery and a global settlement cost (e.g., reflecting any recovery by the carrier and/or any new cash to the claimant). In one embodiment, determining global settlement savings comprises subtracting a global settlement cost (which is a current or present day value) from the PDV of claim exposure remaining after recovery (an amount that, absent the global settlement, the carrier may be obligated to reserve for the ongoing claim exposure). For example, using the figures in the preceding workers' compensation example, where the determined PDV of remaining workers' compensation exposure after the maximum recoverable lien is recovered would be $21,250 and the determined global settlement cost is −$130,000 (a positive cash flow to the carrier), the global settlement savings (in present day value) would be $151,250=$21,250−(−$130,000).

In another example, where the determined PDV of remaining workers' compensation exposure after the maximum recoverable lien is recovered would be $150,000 and the determined cost of the global settlement in present dollars is $50,000 (reflecting a cash payment by the carrier to the claimant for the global settlement), the global settlement savings (in present day value) would be $100,000=$150,000−$50,000. In yet another example, where the determined PDV of remaining workers' compensation exposure after the maximum recoverable lien is recovered would be $35,000 and the determined cost of the global settlement in present dollars is $45,000 (reflecting a cash payment by the carrier to the claimant for the global settlement), the global settlement savings (in present day value) would be −$10,000=$35,000−$45,000. This negative “savings” result indicates that the cost of global settlement would put the carrier in a worse position financially than paying out over time to the claimant for the future exposure. In some embodiments, a global settlement assessment application may recommend not settling on the terms that provided the undesirable result.

In one embodiment, determining a global settlement offer may comprise determining whether an amount of savings is less than, greater than and/or equal to zero (or some other benchmark or threshold value (e.g., $1000) as deemed desirable for a particular application). In one embodiment, determining the global settlement offer may comprise providing an indication (e.g., to a subrogation professional or other user via a client computer) of whether an amount of savings is less than, greater than and/or equal to a desired threshold value. For example, a global settlement application may output to a user, via a computer workstation, an indication of whether a determined global settlement offer would result in a savings amount greater than zero and/or may output an indication of whether the global settlement offer is recommended and/or authorized. For instance, an application may display an audio, video or text message indicating “OK to settle”, “Not OK to settle” or “Settlement is not recommended”, or may represent any of such determinations by indicative highlighting, coloring (e.g., green for positive or zero savings, red for negative savings (a loss)), bolding or the like, as desired for a particular implementation.

According to some embodiments, a threshold savings value (e.g., based on which recommendations may be made) may be predetermined (e.g., by a system or application administrator for all subrogation matters) and/or input or modified by one or more end users. For example, an end user (e.g., a subrogation professional) may enter (e.g., via a user interface) a threshold value of $25,000 applicable for one or more global settlement matters, and global settlement assessment instructions 212-3 may be configured to make a recommendation as to whether to propose and/or accept a particular global settlement offer (e.g., configured by the subrogation professional) based on whether the threshold value is exceeded or not.

In some embodiments, determining a global settlement offer may comprise determining one or more negotiation scenarios based on the PDV of ongoing claim exposure and/or the recoverable lien amount. Some examples of global settlement offers and negotiation scenarios are described in this disclosure, and others will be readily understood by one skilled in the art upon consideration of the disclosure.

Referring now to FIG. 8, a flow diagram of a method 800 according to some embodiments is shown. The method 800 may, for example, be performed by or on behalf of an insurance carrier, a claim professional, a subrogation professional and/or other user. For purposes of brevity, the method 800 will be described herein as being performed by at least one computer (e.g., one or more client computers operated by professionals) on behalf of an insurance company. It should be noted that although some of the steps of method 800 may be described herein as being performed by a client computer while other steps are described herein as being performed by another computing device, any and all of the steps may be performed by a single computing device which may be a client computer, server computer, data provider device or another computing device. Further, any steps described herein as being performed by a particular computing device may be performed by a human or another computing device as appropriate.

According to some embodiments, the method 800 may comprise determining a PDV of claim exposure that will not be satisfied by a third party settlement, at 802. In one example, determining the PDV of such claim exposure that will not be satisfied by a third party settlement may comprise determining the PDV of any ongoing claim exposure that will not be eliminated or extinguished, or will otherwise remain, after recovery by a carrier of a maximum recoverable lien, as discussed above with respect to method 700. Various examples of determining a maximum recoverable lien are described in this disclosure. In one embodiment, the PDV of claim exposure that will not be satisfied or eliminated by a third party settlement may be determined by subtracting a determined recoverable lien amount from the PDV of an amount to settle ongoing claim exposure.

In accordance with some embodiments, the method 800 may comprise determining a global settlement offer to settle claim exposure and lien recovery, at 804. Various examples of determining at least one global settlement offer are discussed above with respect to step 706 of method 700, and others will be readily understood by one skilled in the art as contemplated by the present disclosure. In one example, a claim professional and/or subrogation professional enters information via an interface (e.g., exemplary interfaces 1100 and/or 1150 of FIG. 11A and FIG. 11B), including one or more offer components for at least one negotiation scenario.

In accordance with some embodiments, the method 800 may comprise determining an amount of savings based on the global settlement offer, at 806. Various examples of determining an amount of savings from global settlement of claim and subrogation maters are discussed above with respect to method 700, and others will be readily understood by one skilled in the art as contemplated by the present disclosure. In one example, a global settlement system program (e.g., global settlement assessment instructions 212-3) retrieves from a database and/or receives via input by a user values for a PDV of claim exposure remaining after any recovery and a global settlement cost, and the program calculates the amount of savings based on the PDV of claim exposure remaining and the determined global settlement cost. In one embodiment, an indication of an amount of global settlement savings is output or otherwise transmitted to a client computer and/or user (e.g., via a user interface).

In accordance with some embodiments, the method 800 may comprise determining whether to recommend the global settlement offer, at 808. In one embodiment, determining whether to recommend the global settlement offer may comprise one or more of: determining a threshold savings value, determining a global settlement savings amount (e.g., as described above with respect to step 806) and/or determining whether a global settlement savings amount is greater than a threshold savings value. Some examples of determining when a global settlement may be recommended are discussed above with respect to method 700, and other embodiments will be readily understood by one skilled in the art as also contemplated by the present disclosure. In some embodiments, if a global settlement savings amount is greater than zero, a global settlement assessment program may be configured (e.g., by appropriate program instructions) to recommend the corresponding global settlement offer and/or negotiation scenario by, for example, presenting a text, audio and/or video message (e.g., via a user interface). If the global settlement offer is not recommended, the method may continue with determining one or more different global settlement offers (e.g., including at least one different offer component), at 804. In one embodiment, if the global settlement offer is recommended, the process may continue at 810.

In accordance with some embodiments, the method 800 may comprise submitting or proposing the global settlement offer, at 810. For example, a subrogation professional, claim professional and/or other user may, in response to the recommendation of the global settlement offer, provide (e.g., in person, via email, via a computer network) an indication of the global settlement offer to a supervisor (e.g., for final authorization), a claimant and/or a claimant's representative. In one example, a subrogation professional may discuss the terms of the global settlement offer with a claimant's attorney. In one embodiment, submitting a global settlement offer may comprise transmitting an indication of the global settlement offer to a database and/or a server computer (e.g., for storage in association with a corresponding claim and/or subrogation matter).

Referring now to FIG. 10, a flow diagram of a method 1000 for determining a value to settle ongoing claim exposure according to some embodiments is shown. Although the method 1000 describes determining a present day value to settle ongoing exposure, it will be understood that some embodiments may provide for determining a settlement value of ongoing claim exposure that is not necessarily a present day value and/or is not necessarily based on a PDV of future exposure. The method 1000 may, for example, be performed by or on behalf of an insurance carrier, a claim professional, a subrogation professional and/or other user. For purposes of brevity, the method 1000 will be described herein as being performed by at least one computer (e.g., one or more client computers operated by professionals) on behalf of an insurance company. It should be noted that although some of the steps of method 1000 may be described herein as being performed by a client computer while other steps are described herein as being performed by another computing device, any and all of the steps may be performed by a single computing device which may be a client computer, server computer, data provider device or another computing device. Further, any steps described herein as being performed by a particular computing device may be performed by a human or another computing device as appropriate.

In accordance with some embodiments, the method 1000 may comprise determining an amount of benefits to be submitted to exhaust future credit, at 1002. Various ways of determining such an amount are described in this disclosure and with respect to step 936 of method 900 (FIG. 9). In one example, the amount of benefits is determined based on the statutory future credit available to a carrier and a percentage of benefits owed by the carrier to a claimant going forward.

In some embodiments, the method 1000 may comprise determining whether a percentage of benefits owed (e.g., by a carrier) until a future credit is exhausted is equal to 100%, at 1004. If the percentage of benefits owed is equal to 100% (i.e., the carrier will be not be applying any future credit to future benefits), then the PDV to settle ongoing claim exposure is determined to be equal to a maximum claim settlement value for the claim exposure (e.g., assuming no third party recovery), at 1016. Some examples of determining maximum claim settlement value are described with respect to step 934 of method 900 (FIG. 9). In one example, the maximum claim settlement value may be determined by calculating an amount that is an authorized percentage (e.g., 85%) of the present day value of total future claim exposure (e.g., including future indemnity and/or medical exposure). In another example, determining the maximum (authorized) claim settlement value may be determined by receiving the value from a user (e.g., via a user interface) or from a server computer (e.g., in communication with a database storing an indication of the value in association with the claim). As discussed in this disclosure, determining a maximum claim settlement value does not necessarily have to comprise applying a present day value discount to an authorized settlement value, or determining a respective PDV of any future indemnity and/or medical exposure.

In some embodiments, if the percentage of benefits owed until a future credit is exhausted is not equal to 100% (i.e., some amount of future credit may be applied by a carrier against future benefits on an ongoing basis), the method 1000 may comprise determining whether the amount of submitted benefits to exhaust future credit is less than the maximum claim settlement value, at 1006.

According to some embodiments, a continuing exposure of a carrier represents an ongoing amount an insurance carrier is expected to pay out in future benefits to a claimant until all future credit available is exhausted. Applicants have recognized that, in accordance with some embodiments, if the maximum (authorized) claim settlement value is not less than the amount that would need to be submitted by a claimant for the insurance carrier to exhaust all future credit against the claimant's net settlement, it would be financially prudent to project that a carrier's continuing exposure would end once the claimant had submitted claims in the amount of the maximum settlement value. Further, in such a circumstance, the PDV to settle the ongoing claim exposure (which includes consideration of the availability of future credit) would be equal to the determined continuing exposure.

Accordingly, if, at 1006, it is determined that the maximum claim settlement value is less than the amount that would need to be submitted by a claimant for the carrier to exhaust all future credit, in some embodiments the method 1000 may comprise determining that the PDV to settle ongoing claim exposure is equal to the continuing exposure during application of future credit, at 1010, and determining at 1008 that the continuing exposure during application of future credit is equal to the percentage of benefits owed to exhaust the future credit as applied to the maximum claim settlement value, such as in the following formula:

Continuing Exposure During Application of Future Credit=(Maximum Claim Settlement Value)*(% of Benefits Owed to Exhaust Future Credit)

Applicants have further recognized that, in accordance with some embodiments, if the amount that would need to be submitted by a claimant for the insurance carrier to exhaust all future credit against the claimant's net settlement is less than the maximum (authorized) claim settlement value, it would be financially prudent to assume a carrier's continuing exposure would be the ongoing percentage of the benefits owed to the claimant, as applied to the amount of benefits that would need to be submitted to exhaust the future credit. Applicants have further recognized that, in such a circumstance, after the future credit is exhausted, 100% of any expected future benefits claimed would be paid out. Accordingly, it would be reasonable for a carrier contemplating global settlement to assess the PDV to settle ongoing claim exposure as including the continuing exposure (the amount to be paid out during exhaustion of the future credit), plus all of the future benefits expected to be claimed after exhaustion of the future credit (e.g., until in the aggregate, including benefit claims submitted during and after exhaustion of future credit, the maximum claim settlement value has been submitted).

Accordingly, if, at 1006, it is determined that the amount that would need to be submitted by a claimant for the carrier to exhaust all future credit is less than the maximum claim settlement value, in some embodiments the method 1000 may comprise determining that the continuing exposure during application of future credit is equal to the percentage of benefits owed to exhaust the future credit as applied to the amount of submitted benefits to exhaust future credit, at 1012, and determining that the PDV to settle ongoing claim exposure is equal to the continuing exposure during application of future credit plus any difference between the maximum claim settlement value and the amount of submitted benefits to exhaust the future credit, at 1014. In one embodiment, determining the continuing exposure may be according to the following formula:

Continuing Exposure During Application of Future Credit=(Amount of Submitted Benefits to Exhaust Future Credit)*(% of Benefits Owed to Exhaust Future Credit)

In some embodiments, determining the PDV to settle ongoing claim exposure may comprise using the following formula:

$$PDV to Settle Ongoing Claim Exposure = ( Maximum Claim Settlement Value ) - ( Amount of Submitted Benefits to Exhaust Future Credit ) + ( Continuing Exposure During Application of Future Credit )$$

In one embodiment, one or more of the calculations and formulas described with respect to method 1000 may be performed by a computer (e.g., a user's client computer 104) executing global settlement assessment instructions 212-3, using input values received from a user and/or from a storage device (e.g., in communication with a client computer, server computer and/or data provider device). In one or more embodiments, the determined continuing exposure and/or PDV to settle ongoing claim exposure is displayed or otherwise transmitted to at least one user and/or stored in a database of information (e.g., associated with the corresponding global settlement).

According to some embodiments, one or more of the processes described in this disclosure may comprise one or more of: storing an indication of at least one global settlement offer (e.g., in one or more databases); storing an indication of a final negotiated settlement (e.g., an accepted global settlement offer); storing an indication of at least one offer component; storing an indication of at least one negotiation scenario; transmitting, displaying, presenting or otherwise providing (e.g., to a claim professional, subrogation professional, carrier and/or claimant) an indication of at least one global settlement offer, offer component and/or negotiation scenario; and/or accessing or retrieving (e.g., from a database) an indication of at least one global settlement offer, offer component and/or negotiation scenario.

According to one example system, a global settlement system is integrated as a module or sub-system of a centralized claim management system of an insurance carrier. Integration with a claim management system may allow advantageously for pre-filling, in a user interface for the global settlement system, information retrieved from the claim management system, such as a claimant's or injured worker's name, a name of an insured and/or a claim number. In one embodiment the global settlement system may provide for storing the global settlement assessment results with the main claim file in the claim management system and/or with information associated with a corresponding subrogation matter.

According to one example system, a global settlement system includes an electronic spreadsheet file, such as a Microsoft® Excel® workbook file, as its user interface. The example system optionally includes, and the spreadsheet retrieves information from, one or more databases, such as a Microsoft® Access® database file, using Microsoft® OLE DB technology and/or Microsoft® Visual Basic® for Applications (VBA). The example system optionally uses VBA, or other programming language, to determine automatically one or more values in the spreadsheet file and/or prompt the user for one or more input values. In one example, when a user indicates that a statutory future credit applies in a relevant jurisdiction (e.g., by selecting “Yes” from a dropdown menu) and indicates that statutory future credit does not necessarily equal a net recovery from a third party (e.g., by selecting “No” from a dropdown menu), a VBA module prompts the user to enter the statutory future credit for that jurisdiction via a dialog box and then displays the entered value in the appropriate field of the spreadsheet file.

Any or all of methods 600, 700, 800 and 1000 may involve one or more interface(s), and the methods may include, in some embodiments, providing an interface through which a user may be allowed to enter one or more of claim information, subrogation information, future indemnity and/or medical exposure information, jurisdiction information and/or any other information about a claim, exposure associated with a claim, third party settlement and/or a subrogation matter.

According to one example method, a claim professional and/or subrogation professional responsible for global settlement of a claim and lien recovery matter accesses (e.g., using a smartphone, desktop or laptop computer) a user interface for determining savings associated with global settlement and/or one or more offer components of a global settlement offer. The user interface may be implemented, for example, as a spreadsheet in a spreadsheet application, as a smartphone application and/or as a component or module of a centralized, claim data entry or subrogation matter tracking system. The interface includes fields and other interface elements allowing the professional(s) to enter data associated with the claim and lien recovery matters.

Referring now to FIG. 9A, a flow diagram of a method 900 according to some embodiments is shown. The method 900 may, for example, be performed by or on behalf of an insurance carrier, a claim professional, a subrogation professional and/or other user. For purposes of brevity, the method 900 will be described herein as being performed using exemplary interfaces 1100 and 1150 of FIG. 11A and 11B via at least one computer (e.g., one or more client computers operated by one or more professionals) on behalf of an insurance carrier. It should be noted that although some of the steps of method 900 may be described herein as being performed using the exemplary interfaces 1100 and 1150 via a client computer, any and all of the steps may be performed by a client computer, server computer, data provider device or another computing device. Further, any steps described herein as being performed using a particular computing device may be performed by a human or another computing device as appropriate.

In accordance with some embodiments, the method 900 may comprise determining a third party settlement amount (e.g., to be recovered by a plaintiff/claimant from a third party defendant), at 902 and determining total costs for third party recovery (e.g., plaintiff's attorney costs, statutory deductions related to the carriers recovery), at 904. In one example, a subrogation professional receives the gross third party settlement amount from a claimant (e.g., via the claimant's attorney or other representative) and enters the amount in field 1126 of user interface 1100. The gross third party settlement amount represents the full third party recovery against which the insurance carrier can assert its lien and/or future credit rights. The subrogation professional similarly determines and enters the corresponding plaintiff's attorney fees and costs in field 1128 of user interface 1100.

The method 900 may further comprise determining a net third party settlement amount based on the third party settlement amount and the total costs for third party recovery, at 906. In one example, a global settlement assessment program automatically determines the value of the third party settlement remaining after deduction of corresponding fees and costs by subtracting the plaintiff's costs from field 1128 from the gross third party settlement amount of field 1126, and the program displays the net result via field 1130 of user interface 1100.

The method 900 may further comprise determining a total lien amount, at 908. In one example, a subrogation professional determines the total amount of subrogable benefits paid to a claimant to date (e.g., by accessing and retrieving the information from a claim management system) and enters the total lien amount via field 1132 of user interface 1100.

The method 900 may further comprise determining a legally recoverable lien amount, at 910. In one embodiment, a subrogation professional may review jurisdiction information (e.g., stored in a database) corresponding to the relevant jurisdiction to determine any legal limitations on recovery by the insurance carrier from the third party settlement amount. In one example, a subrogation professional determines an applicable statutory limit on recovery by the insurance carrier for a workers' compensation case in the relevant state, calculates the legally recoverable lien amount based on the determined limit and enters the legally recoverable lien amount in field 1134 of user interface 1100.

The method 900 may further comprise determining a maximum recoverable lien amount, at 912. Various examples of determining a maximum recoverable lien amount are discussed above with respect to method 700 (FIG. 7). In one example, the maximum recoverable lien amount is equal to the legally recoverable lien amount in field 1134. In one embodiment, a subrogation professional and/or claim professional determine the maximum recoverable lien amount based on the legally recoverable lien amount and/or one or more additional considerations associated with the third party recovery and/or claim, such as the amount of funds actually available to the third party defendant to satisfy the third party settlement with the plaintiff/claimant. In one example, a subrogation professional enters the maximum recoverable lien amount in field 1136 of user interface 1100.

The method 900 may further comprise determining a net recovery to the claimant (e.g., an amount that a claimant would receive if the insurance carrier maximizes its lien recovery), at 914. In one example, a global settlement assessment application automatically determines the net settlement to an injured worker by subtracting the maximum recoverable lien amount entered in field 1136 from the net third party settlement amount in field 1130 of user interface 1100.

Referring now to FIG. 9B, the method 900 may further comprise determining whether a statutory future credit applies to the insurance carrier's lien recovery (e.g., in the relevant state or other jurisdiction), at 916. In one embodiment, a subrogation professional may review jurisdiction information (e.g., stored in a database) corresponding to the relevant jurisdiction to determine whether a statutory future credit is available to the insurance carrier to apply against any future benefits owed to the claimant. In another embodiment, a global settlement assessment program may determine the appropriate state based on an entered claim number (e.g., by sending a database request to a server computer in communication with claim data 292) and look up information for that state (e.g., by sending a database request to a data provider device or other computer in communication with a stored database of jurisdiction information) to determine whether a statutory future credit is applicable. In one example, a subrogation professional enters “Yes” or “No” or selects “Yes” or “No” in an appropriate user interface (e.g., combobox element 1140 of user interface 1100) to indicate whether a statutory future credit is applicable in the state. In one embodiment, if no statutory future credit is available to the insurance carrier, the method 900 may determine that an amount of statutory future credit is zero and/or the method 900 may continue with one or more of the described steps (e.g., to determine a percentage of benefits owed, at 924).

The method 900 may further comprise, if the insurance carrier is entitled to apply a statutory future credit against future benefits owed to the claimant, determining whether the available statutory future credit is equal to the net recovery to the claimant, at 918. For example, in some jurisdictions, an insurance carrier may apply a statutory future credit against the future benefits owed a claimant up to the net recovery by the claimant. In one example, a subrogation professional enters “Yes”, “No” “N/A”, “Not Applicable” or the like, or selects one of such indications from a combobox form element in field 1142 to indicate whether the statutory future credit allows for the credit to be applied in an amount up to the net recovery by the claimant. In another example, if the global settlement assessment program determines at 916 that a statutory future credit is not available, the program may automatically update (as necessary) field 1142 of the user interface 1100 to indicate “No”, “N/A”, “Not Applicable” or the like.

The method 900 may further comprise, if the statutory future credit is determined to be equal to the net recovery to the claimant at 918, setting or otherwise establishing the statutory future credit amount available for the claim exposure and subrogation recovery cases equal to the net recovery to the claimant, at 920. In one example, in response to determining that the statutory future credit is equal to the net recovery to the claimant, the global settlement assessment program updates the user interface 1100 to include the value of the net recovery of the claimant in field 1144.

The method 900 may further comprise, if the statutory future credit is determined not to be equal to the net recovery to the claimant at 918, determining the statutory future credit amount available to the insurance carrier, at 922. In one example, a claim professional and/or subrogation professional inputs an amount of statutory future credit available for the recovery case (e.g., in field 1144 of the user interface 1100). In another example, in response to determining that the statutory future credit is not equal to the net recovery to the claimant (e.g., by a user selecting “No” from a combobox or dropbox menu at field 1142 of user interface 1100), the global settlement assessment program prompts the user (e.g., via a dialog box) to enter the statutory future credit available for the recovery (e.g., in a field, via a dialog box). A professional may consult, for example, jurisdiction information corresponding to the relevant jurisdiction to determine what future credit may be available. In another example, a global settlement system may access jurisdiction information (e.g., via a server computer or data provider device) that indicates the amount of statutory credit available in a particular jurisdiction (e.g., based on other case facts entered in a user interface or otherwise determined by a global settlement assessment program). The program may then display the determined value in field 1144 of the user interface 1100.

The method 900 may further comprise determining a percentage of benefits owed until future credit is exhausted, at 924. In some jurisdictions, an insurance carrier can apply a future credit against future benefits, but not all of them—the insurance carrier may owe to a claimant (e.g., an injured worker) a percentage of benefits claimed by the claimant, even while applying the future credit. In one example, a subrogation professional inputs, or selects from a list of available percentages, a percentage of benefits owed by an insurance carrier to a claimant while the future credit is being exhausted, in field 1146 of user interface 1100.

Referring now to FIG. 9C, the method 900 may comprise determining PDV for future indemnity exposure, at 926, determining PDV for future medical exposure, at 928 and determining the PDV of future claim exposure based on the PDV for future indemnity exposure and PDV for future medical exposure), at 930.

In one example, a claim professional determines the PDV of future indemnity and/or medical exposure (e.g., based on claim data 294) and enters the appropriate amounts in corresponding field 1110 and field 1112 of user interface 1100. For instance, the claim professional may access a system for managing claim information (e.g., claim management system 180), enter a claim number or other information for identifying the relevant claim matter, view or otherwise receive information related to past benefits paid and/or ongoing claim exposure provided by the system to the claim professional (e.g., via a client computer 104) and input the exposure information using the user interface 1100.

In another example, global settlement system 170 uses a claim number input by a user in field 1102 of user interface 1100 to request claim exposure information for the corresponding claim from a computer or other device storing claim data 292 (e.g., server computer 102). In response, the device returns information including future indemnity exposure and/or future medical exposure to the global settlement system, which displays a representation of the information to the user (e.g., via fields 1110 and/or 1112 of user interface 1100).

In yet another example, user interface 1100 and/or a global settlement program application may determine the future indemnity exposure and/or future medical exposure (e.g., as input by a user or received from a database of claim information) and calculate a total claim exposure by adding the future indemnity exposure and the future medical exposure.

In another example, global settlement assessment instructions 212-3 are configured to display a representation of the PDV of total future claim exposure via field 1114 of user interface 1100.

The method 900 may comprise determining an authorized percentage of settlement for claim resolution, at 932 and/or determining a maximum claim settlement value based on PDV of future claim exposure and the authorized percentage of settlement for claim resolution, at 934. As discussed in this disclosure, an authorized percentage of settlement may refer to a percentage of a present value or settlement value (e.g., of a determined future exposure amount) authorized (e.g., by a carrier or representative of a carrier) for settlement of claim resolution (e.g., with a claimant). Accordingly, the determined maximum claim settlement value may represent a monetary amount at which an insurance carrier may be willing to settle any ongoing claim exposure with a claimant (e.g., if there were no related third party settlement to consider as part of a global resolution).

In one example, a claim professional determines the authorized percentage at which the insurance carrier would be willing to settle a compensation claim case (e.g., absent any third party settlement considerations) and enters the authorized percentage in field 1116 of user interface. In another example, an indication of the authorized percentage of settlement is stored (e.g., in claim data 292) in association with the underlying claim and a global settlement application or global settlement system 170 determines the authorized percentage by accessing the stored indication (e.g., using a corresponding claim number). In one example, determining the maximum claim settlement value comprises applying the authorized percentage to the PDV of future claim exposure to calculate the maximum claim settlement value. For instance, referring to the example information in user interface 1100, the authorized 85% of settlement in field 1116 may be multiplied by the PDV of future claim exposure indicated in field 1114 to calculate the maximum claim settlement value of $637,500, as depicted in field 1118.

In some embodiments, determining the maximum or authorized claim settlement value may not comprise determining an authorized percentage of settlement, and may not comprise calculating the maximum claim settlement value based on an authorized percentage of settlement and a PDV of future claim exposure. For example, in some embodiments determining the maximum claim settlement value may comprise receiving the maximum claim settlement value, for example, from a user (e.g., via a user interface) or accessing a database to retrieve an indication of the maximum claim settlement value (e.g., stored in association with a claim).

In some embodiments, the method 900 may further comprise displaying the authorized percentage and/or maximum settlement value via user interface 1100, otherwise transmitting an indication of the authorized percentage to a user and/or storing a representation of the authorized percentage and/or maximum settlement value (e.g., in a database).

Referring now to FIG. 9D, the method 900 may comprise determining an amount of benefits to be submitted to exhaust future credit, at 936. In some embodiments, determining the amount of benefits to be submitted to exhaust future credit comprises determining the amount of benefits an injured worker or other claimant would have to submit in order for the insurance carrier to exhaust all of the future credit available to apply against such benefits. In one embodiment, the amount of benefits to be submitted may comprise determining a future credit available to an insurance carrier (e.g., as discussed above with respect to steps 920 and 922) and/or determining a percentage of benefits owed until the future credit is exhausted (e.g., as discussed above with respect to step 924).

Some jurisdictions, such as New York and Connecticut, currently require that an injured worker must personally exhaust the statutory future credit before workers' compensation benefits are payable in full. In contrast, some states, such as Pennsylvania, do not require an injured worker to exhaust the statutory future credit before benefits are payable. Accordingly, in some embodiments, determining the amount of benefits to be submitted to exhaust any future credit may comprise determining the applicable jurisdiction and/or determining whether an injured worker or other claimant must personally exhaust the statutory future credit before benefits are payable in full by an insurance carrier.

In one embodiment, a subrogation professional may review jurisdiction information (e.g., stored in a database) corresponding to the relevant jurisdiction to determine whether an injured worker or other claimant must personally exhaust the statutory future credit. In another embodiment, a global settlement assessment program may determine the appropriate state, in a manner similar to that discussed with respect to 916 (e.g., based on an entered claim number and/or by sending a database request to a server computer in communication with claim data 292) and/or look up information for the appropriate state (e.g., by sending a database request to a data provider device or other computer in communication with a stored database of jurisdiction information) to determine whether an injured worker or other claimant must personally exhaust the statutory future credit. In one example, a subrogation professional enters “Yes” or “No” or selects “Yes” or “No” in an appropriate user interface (e.g., combobox element 1145 of FIG. 11A) to indicate whether an injured worker or other claimant must personally exhaust the statutory future credit in the state.

If a particular injured worker must exhaust the statutory future credit (e.g., based on the applicable jurisdiction), the amount of benefits the injured worker would need to submit before the insurance carrier exhausted the future credit may be calculated as:

Amount of Benefits to be Submitted=Statutory Future Credit/(1−Percentage of Benefits Owed)

In one example, as depicted in user interface 1100 (FIG. 11A) an insurance carrier has a $530,000 statutory future credit available to apply against future benefits owed to an injured worker, but the insurance carrier is also obligated by statute to pay 30% of all such claims to the claimant even while the future credit is being applied. Applying the above formula, the claimant would have to submit a total of $757,143 in benefits to exhaust the future credit of $530,000.

If the injured worker does not have to exhaust the statutory future credit, the injured worker would need to submit only up to the amount of the future credit. In other words, the amount of benefits to be submitted to exhaust the future credit is equal to the amount of the future credit. For example, if an insurance carrier has a $530,000 statutory future credit available to apply against future benefits owed to an injured worker, the claimant would have to submit only $530,000 in benefits to exhaust the future credit.

In another example, if no future credit is available or an insurance carrier otherwise is obligated to pay all (i.e., 100%) of benefits owed going forward, the amount of benefits to be submitted may be determined to be zero for purposes of global resolution.

The method 900 may comprise determining continuing exposure during application of future credit, at 938, and/or determining PDV to settle ongoing claim exposure, at 940. In some embodiments, as discussed with respect to method 1000 of FIG. 10, determining the continuing exposure may comprise determining an ongoing amount an insurance carrier is expected to pay out in future benefits to a claimant until all future credit available is exhausted. As also discussed with respect to method 1000, determining the PDV to settle ongoing claim exposure may comprise, in some embodiments, determining the present day value to settle ongoing claim exposure (e.g., for a workers' compensation claim) after application of any available future credit. Accordingly, in contrast to the maximum settlement value discussed above with respect to step 934, which is determined without regard to any third party recovery or related future credit, determining the PDV to settle ongoing claim exposure takes into account a carrier's opportunity to apply any future credit to continuing exposure (and the present day value of any associated savings). Some example formulas that may be implemented via a spreadsheet file, other user interface and/or a global settlement assessment program are discussed with respect to method 1000.

In one example, a user enters the corresponding values via a user interface, such as in fields 1122 and 1124 of user interface 1100. In another example, a global settlement assessment program retrieves the information from claim data 292, subrogation data 294 and/or stored global settlement data associated with the corresponding global settlement matter.

In another example, and referring to example user interface 1100, a user interface and/or global settlement assessment program is configured to determine continuing exposure during application of future credit automatically based on determined values including: a percentage of benefits owed to exhaust future credit (30.00% as depicted in field 1146), an amount of submitted benefits to exhaust any future credit ($757,143 as provided in field 1120) and a maximum settlement value for claim exposure without future credit ($637,500 as provided in 1118). In this example, the carrier could expect that its continuing exposure would end once the claimant had submitted claims in the amount of the maximum (authorized) settlement value ($637,500). Accordingly, in this example, the (maximum) continuing exposure the carrier would be willing to assume during application of future credit settlement is $191,250, which is equal to 30% of the maximum claim settlement value of $637,500.

Referring now to FIG. 9E, the method 900 may comprise determining the PDV of claim exposure remaining after the maximum recoverable lien is recovered, at 942. As described in this disclosure, the PDV of claim exposure remaining may be useful, in some embodiments, for assessing the optimization of a negotiation scenario and/or global settlement offer, such as by determining an amount of global settlement savings. In one embodiment, determining the PDV of claim exposure remaining comprises subtracting the maximum recoverable lien form the determined PDV to settle ongoing claim exposure. In one example, as depicted in user interfaces 1100 and 1150 of FIG. 11A and FIG. 11B, the PDV of claim exposure remaining of ($21,250 in field 1160) is determined by subtracting the maximum recoverable lien of $170,000 from field 1136 (or field 1158) from PDV to settle ongoing claim exposure of $191,250 from field 1124 (or field 1156).

In some embodiments, the method 900 may comprise determining an offer to settle indemnity exposure, determining an offer to fund a Medicare set aside (MSA) and/or determining an offer to settle non-MSA medical exposure, at 944, 946 and 948, respectively. As discussed in this disclosure, an offer (or offer component) to settle indemnity exposure may comprise new or fresh cash to a claimant for indemnity exposure. An offer to contribute an amount to a Medicare set aside fund may be considered for certain medical expenses for which Medicare will not allow settlement of a compensation claim. An offer for other medical exposure (e.g., non-MSA exposure) may be considered where the expense is not appropriate for MSA, such as for prosthetics. In one example, as depicted under “Scenario 1” of user interface 1150, an offer to settle indemnity exposure is $65,000 (in field 1162) and there are no offers for MSA (field 1164) or non-MSA (field 1166) future medical.

In some embodiments, the method 900 may comprise determining a negotiated lien recovery amount, at 950. The negotiated lien recovery amount may be determined, in some embodiments, by a subrogation professional and/or claim professional based on the maximum recovery lien. In one example, in “Scenario 1” of user interface 1150, a considered lien recovery in field 1168 is $40,000 (compared to the expected maximum recovery lien of $170,000 in field 1158).

In some embodiments, the method 900 may comprise determining a total cost for global settlement, at 952. As discussed above with respect to method 700, determining a total cost for a proposed global settlement (e.g., one of the at least one contemplated negotiation scenarios) may comprise summing any new cash or MSA funding offer components and subtracting from that sum any negotiated lien recovery. In one example, referencing the user interface 1150, the total claim cost (in field 1170) to achieve global settlement of a workers' compensation case under “Scenario 1” is $25,000=$65,000 (new cash to settle indemnity exposure in field 1162)+$0 (offer to fund MSA in field 1164)+$0 (offer to settle non-MSA medical exposure in field 1166)−$40,000 (negotiated lien recovery in field 1168).

In some embodiments, the method 900 may comprise determining savings from the PDV of the remaining claim exposure, at 954. Global settlement savings is described further above with respect to method 700. In one embodiment, determining savings from the PDV of the remaining claim exposure comprises subtracting any cost to achieve global settlement (e.g., new cash and/or MSA funding) from the determined PDV of remaining claim exposure after the maximum recoverable lien is recovered. In one example, as depicted in user interface 1150 under “Scenario 1”, the global settlement savings from the PDV of remaining claim exposure (in field 1172) is −$3,750=$21,250−$25,000.

In some embodiments, as discussed in this disclosure, a global settlement assessment utility, program or user interface may provide a recommendation as to whether to pursue a particular global settlement offer or negotiation scenario. In one embodiment, a user interface displays an indication of whether to settle using a particular global settlement offer based on whether the global settlement savings is not less than zero. As depicted in “Scenario 1” of user interface 1150, the entered offer components result in a negative savings (a cost) to the insurance carrier of $3,750.Accordingly, the user interface 1150 is caused (e.g., by a processor executing global settlement assessment instructions 212-3 to display an indication that it is “NOT OK TO SETTLE” at 1152. In contrast, the user interface 1150 indicates that for the “Scenario 2,” “Scenario 3” and the “Final Settlement” scenarios, based on the respective global settlement savings, it is “OK TO SETTLE”.

Accordingly, with respect to some embodiments, the user(s) of a user interface may be able to consider whether one or more global settlement offers provides savings in present day value with respect to remaining claim exposure, to compare conveniently the respective costs and savings for two or more global settlement offers, to conveniently consider variations of a global settlement offer (or offers) by modifying one or more components of a global settlement offer (or offers) and to email or otherwise transmit one or more global settlement offers.

As discussed above, FIG. 11A illustrates an example interface 1100 through which one or more users (e.g., a claim professional and/or subrogation professional) may enter claim and/or subrogation information. FIG. 11B illustrates an example interface through which one or more users may enter information related to one or more global settlement offers or negotiation scenarios. Through such an interface 1100 or 1150 a user may be able to enter one or more of: a claim number (field 1102), an insured's name (field 1104) and/or an injured worker's (or other type of claimant's) name (field 1106). Such information may be used, in some embodiments, in retrieving related information associated with a particular claim and/or subrogation matter (e.g., by accessing claim data 292 and/or subrogation data 294).

Although certain types of information are illustrated in the example interfaces 1100, 1150 and 1300, those skilled in the art will understand that the interfaces may be modified in order to provide for additional types of information and/or to remove some of the illustrated types of information, as deemed desirable for a particular implementation.

The example interfaces 1100 and 1150 also include an interface element 1148 allowing a user to reset or clear the interface fields (e.g., by using a pointer or other input device to actuate the “RESET” button). The example interfaces 1100 and 1150 also include an interface element 1152 (the “SAVE” button) allowing the user to save information entered and/or displayed via the interface (e.g., in one or more databases configured to store claim data, subrogation data and/or global settlement data). The example interfaces 1100 and 1150 also include an interface element 1150 (the “EMAIL” button) for communication of information entered in the interface and/or determined using the interface (e.g., an email message providing information relating to one or more global settlement offers in the text of the message or as an attachment).

The example interface 1100, in some embodiments, also provides a section to provide and determine information related to a claim and a section to provide and determine information related to subrogation. The example interface 1150, in some embodiments, provides a section for entering and determining information related to particular global settlement offers, including a “Final Settlement” that may be used to indicate a final agreement reached with respect to global settlement of a claim exposure matter and a lien recovery matter.

Although interface 1100, interface 1150 and interface 1300 are illustrated for convenience of discussion as different interfaces, those skilled in the art will readily understand, in light of the present disclosure, that the features and information of those interfaces, or a subset of such features and information, may be included in a single interface, screen display or application window, or in more than three such interfaces, displays or application windows. For example, a single interface window may be used for inputting relevant claim information, subrogation information and global settlement offer component information on the same screen, tab or page of the interface.

Although example interfaces 1100, 1150 and 1300 are illustrated as including particular text and interface elements (e.g., text descriptions, fields for data entry or display), it will be understood by those skilled in the art, in light of the present disclosure, that not all of the example interface features and elements depicted are necessary and that additional features and elements may be provided, in accordance with some embodiments, as deemed desirable for a particular implementation. For example, although example interface 1150 provides for entry and/or display of an offer to fund MSA, as discussed above, some embodiments (e.g., for small value cases) may not provide for MSA funding, and a corresponding user interface may not provide for entry or determination of an MSA funding offer component. In another example, as discussed above, some embodiments may not require entering or determining an authorized % of settlement for a PDV exposure amount; a corresponding interface may not provide for entry or determination of an authorized % of settlement.

According to a further example method, a claim professional and/or subrogation professional responsible for global settlement of a claim and lien recovery matter accesses (e.g., using a smartphone, desktop computer, tablet computer or laptop computer) a user interface for determining actual savings of an insurance carrier as a result of a global settlement associated with a workers' compensation claim. The savings may include any reduction or elimination of any likely future payout(s) as a result of resolving a subrogation claim. In one example, determining the savings is based on the projected future exposure (e.g., indemnity and/or medical exposure) of the insurance carrier and not on the PDV of that exposure. The user interface may be implemented, for example, as a spreadsheet in a spreadsheet application, as a smartphone application and/or as a component or module of a centralized, claim data entry or subrogation matter tracking system.

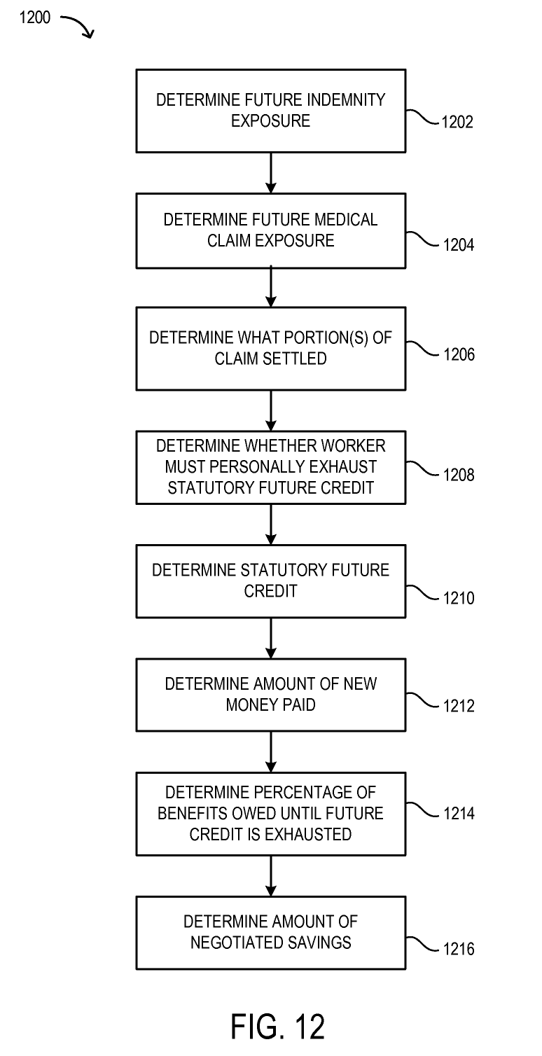

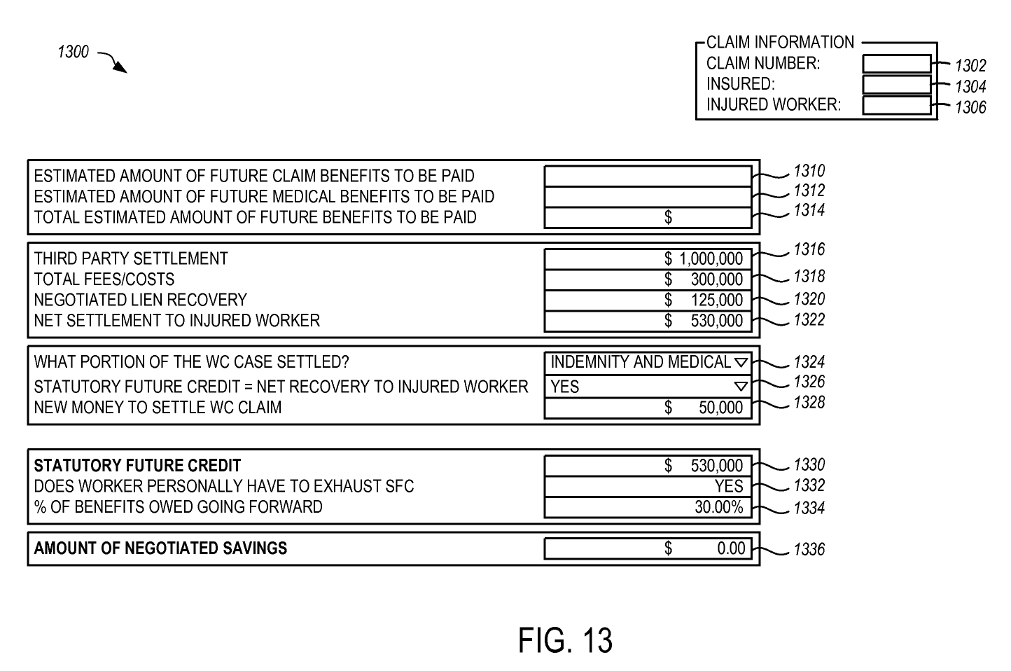

Referring now to FIG. 12, a flow diagram of a method 1200 according to some embodiments is shown. The method 1200 may, for example, be performed by or on behalf of an insurance carrier, a claim professional, a subrogation professional and/or other user. For purposes of brevity, the method 1200 will be described herein as being performed using exemplary interface 1300 of FIG. 13 via at least one computer (e.g., one or more client computers operated by one or more professionals) on behalf of an insurance carrier. It should be noted that although some of the steps of method 1200 may be described herein as being performed using the exemplary interface 1300 via a client computer, any and all of the steps may be performed by a client computer, server computer, data provider device or another computing device. Further, any steps described herein as being performed using a particular computing device may be performed by a human or another computing device as appropriate.

In accordance with some embodiments, the method 1200 may comprise determining an estimated amount of future indemnity benefits to be paid (e.g., by an insurance carrier based on a workers' compensation claim), at 1202, and determining an estimated amount of future medical benefits to be paid, at 1204. Various ways of determining such estimated amounts are discussed in this disclosure (e.g., with respect to example database fields 308 and 312, and step 702 of method 700). In one example, a subrogation professional and/or workers' compensation professional determines the estimated amount of future claim benefits and enters the amount in field 1310 of user interface 1300. In another example, a user determines the estimated amount of future medical benefits and enters the amount in field 1312 of user interface 1300. In some embodiments, method 1200 may further comprise determining an estimated total amount of future benefits (e.g., indemnity benefits and medical benefits) to be paid. The total estimated amount of future benefits to be paid may be determined, for example, automatically via user interface 1300 by adding estimates in field 1310 and field 1312, and may be stored and/or displayed, for example, in field 1314.

The method 1200 may further comprise determining what portion (or portions) of a claim settled (e.g., in a global settlement), at 1206. For example, only indemnity benefits, only medical benefits, or both indemnity and medical benefits may be settled. In one example, a subrogation professional enters “Indemnity and Medical” or “Indemnity Only” or selects “Indemnity and Medical” or “Indemnity Only” in an appropriate user interface (e.g., combobox element 1324 of user interface 1300) to indicate the portion(s) of a claim that were settled as a part of a global settlement. In one example, if indemnity and medical portions are settled, then a statutory future credit is not applicable.

The method 1200 may further comprise determining whether an injured worker must personally exhaust any statutory future credit, at 1208. Various examples of determining whether an injured worker must personally exhaust any statutory future credit are discussed in this disclosure, including with respect to FIG. 9D (936). As noted above, in some instances, if both indemnity and medical portions are settled, then a statutory future credit is not applicable. If a statutory future credit is applicable, whether the injured worker must personally exhaust any statutory future credit may be determined based on the appropriate jurisdiction.

The method 1200 may further comprise determining an appropriate statutory future credit, at 1210. Various factors and methods are discussed in this disclosure that may be useful, in accordance with some embodiments, for determining a statutory future credit (e.g., associated with a workers' compensation claim), including the discussion of FIG. 9B (916, 918, 920 and 922). In one example, determining the appropriate statutory future credit may be based on whether or not a statutory future credit equals the net recovery to an injured worker.

The method 1200 may further comprise determining an amount paid to an injured worker or other claimant in settling indemnity and/or medical exposure, at 1212. Such an amount may be referred to as “new money.” In one example, determining an amount of new money paid in settling a claim may include determining an amount provided to settle indemnity exposure, an amount provided to fund MSA and/or an offer to settle non-MSA medical exposure. In one example, determining an amount of new money paid may include totaling the amounts entered in fields 1180, 1182 and 1184 in interface 1150 (FIG. 11B).

The method 1200 may further comprise determining a percentage of benefits owed going forward (e.g., owed by an insurance carrier), at 1214. Various examples of determining the percentage owed are discussed in this disclosure, including with respect to FIG. 9B (924).

The method 1200 may further comprise determining an amount of negotiated savings, at 1216. In accordance with some embodiments, “negotiated savings” refers to savings of an insurance carrier as a result of a global settlement associated with a workers' compensation claim (versus paying out projected future benefits). The amount of negotiated savings may depend on a variety of factors, including, without limitation: (i) an amount of future claim exposure, (ii) an amount of medical claim exposure, (iii) whether a statutory future credit applies, (iv) an amount of applicable statutory future credit (if any), (v) whether an injured worker must personally exhaust statutory future credit, (vi) what portion(s) of a claim settled, (vii) an amount of new money paid and/or (viii) a percentage of benefits owed going forward.

In one example, if both indemnity and medical portion(s) of a claim were settled, an amount of negotiated savings is equal to a total estimated amount of future benefits to be paid (including any future indemnity benefits and future medical benefits), less any new money paid.

In another example, if only the indemnity portion was settled and a statutory future credit does not apply, an amount of negotiated savings is equal to an estimated amount of future indemnity benefits to be paid, less any new money paid.

In another set of examples, only the indemnity portion was settled and an injured worker must personally exhaust the statutory future credit. If the estimated amount of future medical benefits multiplied by (1−% of benefits owed going forward) is greater than the statutory future credit, then the amount of negotiated savings is equal to an estimated amount of future indemnity benefits to be paid, less any new money paid, plus the amount of the statutory future credit. If, on the other hand, the estimated amount of future medical benefits multiplied by (1−% of benefits owed) is not greater than the statutory future credit, then the amount of negotiated savings is equal to an estimated amount of future indemnity benefits to be paid, less any new money paid, plus the estimated amount of future medical benefits multiplied by (1−% of benefits owed).

In another set of examples, only the indemnity portion was settled and an injured worker does not have to exhaust the statutory future credit personally. If the statutory future credit is greater than the estimated amount of future medical benefits, then the amount of negotiated savings is equal to an estimated amount of future indemnity benefits to be paid, less any new money paid, plus the estimated amount of future medical benefits multiplied by (1−% of benefits owed). If, on the other hand, the statutory future credit is not greater than the estimated amount of future medical benefits, then the amount of negotiated savings is equal to an estimated amount of future indemnity benefits to be paid, less any new money paid, plus the amount of the statutory future credit multiplied by (1−% of benefits owed).

One or more types of information may be displayed and/or utilized by the example user interface 1300, which may be useful in performing one or more steps of the example method 1200. Example user interface 1300 comprises example fields, including, without limitation: claim number field 1302, insured name field 1304, injured worker field 1306, estimated future indemnity exposure field 1310, estimated future medical exposure field 1312, total estimated amount of future benefits field 1314, an amount of a third party settlement field 1316, an amount of total fees/costs associated with a settlement field 1318, an amount of a negotiated lien recovery field 1320, a net settlement to the injured worker field 1322, what portion(s) of a workers' compensation case settled field 1324, whether a statutory future credit is equal to a net recovery to an injured worker field 1326, a negotiated lien recovery field 1328, an amount of statutory future credit field 1330, whether a worker has to exhaust a statutory future credit personally field 1332, a percentage of benefits owed going forward field 1334 and/or an amount of negotiated savings 1336.

According to one example, the global settlement system 170 uses a claim number input by a user in field 1302 of user interface 1300 to request information for the corresponding claim and/or subrogation case from a computer or other device storing claim data 292 and/or subrogation data 294 (e.g., server computer 102). According to other embodiments, one or more fields of user interface 1300 may be integrated with, access and/or reference values of one or more other interfaces (e.g., interfaces 1100 and/or 1150), and/or reference the same values (e.g., as may be stored in one or more databases) utilized by one or more other interfaces described in this disclosure. In some embodiments, one or more fields of user interface 1300 may be prefilled with values from user interfaces 1100 and/or 1150. For example, when a user opens user interface 1300, third party settlement field 1316 may reference and be prefilled with the corresponding value from field 1126 of user interface 1100 (FIG. 11A).

Although some examples in this disclosure describe entry of one or more values (e.g., a third party settlement, PDV of a future indemnity exposure) by a user for use in determining one or more negotiation scenarios (e.g., global settlement offers), it is also described in this disclosure and will be readily understood that, rather than being entered manually, one or more of such values may be retrieved, for example, from one or more databases and/or received (e.g., via a network) by one computer from another computing or storage device. In some embodiments, one or more of the values described as input and/or determined with respect to example interfaces 1100, 1150 and/or 1300 may be presented to a user automatically. For example, stored values may be used to populate one or more fields of a user interface based on information retrieved automatically from a database (e.g., using a claim number and/or subrogation matter identifier entered by a user).

Similarly, although some examples described in this disclosure (e.g., example interfaces 1100, 1150 and 1300) provided for manual entry of one or more components of an actual or simulated global settlement offer, it will be readily understood that one or more such components may be determined automatically for presentation to a user. In one embodiment, based on stored claim and subrogation information, PDV of remaining claim exposure, a predetermined threshold value for settlement costs and/or a predetermined threshold value for settlement savings, one or more offer components of a negotiation scenario may be determined according to stored program instructions and displayed or otherwise transmitted to a user. In another embodiment, multiple such negotiation scenarios may be determined.

In some embodiments, one or more offer components may be determined at random or determined at random from within a predetermined range of offer amounts. In some embodiments, one or more offer components, such as an offer to settle workers' compensation indemnity exposure, may be determined based on a predetermined value or value derived in real time, such as a determined average offer for indemnity exposure in prior successful global settlements.

In some embodiments, one or more sets of offer components (e.g., $10,000 for indemnity exposure and $90,000 for negotiated lien recovery) may be determined based on a determined PDV of remaining exposure and/or minimum desired global settlement savings value. For example, global settlement assessment instructions may be configured to automatically suggest three negotiation scenarios, each having different respective component values, but each also resulting in a global settlement savings of at least $25,000 if accepted. Other such rules and criteria for automatically determining and/or suggesting to a user one or more offers or offer components will be readily understood by those skilled in the art in light of this disclosure.

Some embodiments provide for assessing whether to accept a global settlement offer submitted to a carrier (e.g., by or on behalf of a claimant). For example, the functionality for entering or retrieving offer components described with respect to example interface 1150 may be used to enter an offer suggested by a claimant, and the interface may function (as described variously above) to determine an associated settlement cost, savings and/or recommendation as to whether to accept the received offer. In one embodiment, program instructions may be configured to determine and suggest a counter-offer with respect to one or more components as described above (e.g., based on historical information about accepted and/or rejected global settlement offers).

Although the example interfaces 1100, 1150 and 1300 are described as displaying all entered, received, retrieved, determined and/or calculated values to a user (e.g., via a display of a computer), it will be readily understood that in some embodiments one, some or all of such values may not be presented to a user. In one embodiment, for example, most of the entered and derived values depicted in the example claim and subrogation sections of example interface 1100 may be retrieved and/or determined automatically according to program instructions, but not displayed, and only the example PDV value of WC exposure may be displayed to the user for reference in entering components of one or more negotiation scenarios.

As discussed above, some embodiments may provide for determining a measure of a carrier's savings achieved through global settlement or otherwise assessing a carrier's success in global settlement negotiations. In one embodiment, stored information about a plurality of final global settlement offers may be accessed and analyzed to determine an aggregate measure of savings for the plurality of global settlements. For example, each of a set of global settlements for a given time period may have associated with it a respective settlement cost and/or settlement savings, and global settlement assessment instructions may be configured to calculate a total savings and/or determine an average savings (e.g., per settlement, per year or other desired time period) for the plurality of settlements. In another example, program instructions may be configured to derive such savings from stored and/or entered information for each final global settlement, as described variously in this disclosure, and provide the desired analysis of information (e.g., total savings) for a plurality of global settlements.

Some embodiments described in this disclosure provide for determining whether or when to submit an offer for global settlement. In one embodiment, an interface may recommend a global settlement offer (e.g., “OK to settle”) for an ongoing global settlement negotiation. In another embodiment, a system (or user) may anticipate the possibility of a third party settlement and may, from time to time, enter or otherwise determine (e.g., by retrieving from a database) current claim information and (projected) settlement information for a claim in order to assess the potential benefits of global settlement (e.g., potential settlement savings) even though the carrier and claimant are not yet discussing the possibility of global settlement. In this way, a system may suggest global settlement where negotiations have not yet begun (and where global resolution is possible in the jurisdiction). In one embodiment, a user (or system) may discover, based on current projections of future indemnity and/or medical exposure and an estimated outcome of third party settlement, that a carrier could achieve significant savings through negotiated global settlement. In such a case, a system may generate automatically a signal or alert, e.g., via email, text/SMS message, website and/or any other communications technology, to alert the carrier (e.g., a representative and/or professional of the carrier) that now is a good time to settle the case or to make an offer to settle the case. In one example, detection of an increase in a workers' compensation reserve, in which the increase is greater than a predetermined threshold amount, may trigger an alert. Based on such a determination and/or signal, the carrier may decide to initiate global settlement with the claimant. According to one embodiment, a user (e.g., a recipient of an alert that global resolution may be desirable) may indicate to the system that he or she no longer wishes to receive alerts (e.g., because global settlement cannot be achieved).

Some embodiments, as discussed in this disclosure, provide for a global settlement system 170 integrated into a central claim management system 180. Several of the factors and information discussed in this disclosure are dependent on the jurisdiction associated with the claim (e.g., as stored in claim data 292). Accordingly, if the global settlement system 170 can determine the appropriate jurisdiction, some types of related information may be determined automatically rather than having to rely on manual input from a user. For example, using the jurisdiction, the global settlement system 170 may be able to access jurisdiction information for that jurisdiction (e.g., stored at server computer 102) and determine, without input from a user, one or more of: whether a statutory future credit is applicable, whether the future credit is equal to the net recovery of the injured worker, how to calculate the statutory future credit and/or whether an injured worker must exhaust the statutory future credit. Any one or more values determined in this manner may be used, as desirable, to populate automatically corresponding fields of a user interface (e.g., user interface 1100).

Similarly, types of information other than those related to jurisdiction may be stored (e.g., via claim management system 180) and retrieved to populate one or more fields of a user interface. In one example, estimated amounts of future claim and/or medical benefits (and/or PDV of such estimates) may be stored and used to fill in corresponding interface fields. In this way users may have to input manually only variable information for exploring different settlement scenarios, for example.

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

Neither the Title (set forth at the beginning of the first page of this disclosure) nor the Abstract (set forth at the end of this disclosure) is to be taken as limiting in any way as the scope of the disclosed invention(s).

According to some embodiments, methods include facilitating settlement with respect to both (1) benefits owed by an insurance carrier to a claimant (e.g., based on an injured worker's claim for benefits under a workers' compensation policy) and (2) a lien (or subrogation interest) of the insurance carrier against recovery by the claimant from a third party defendant (e.g., accused of causing the injury).

In accordance with some embodiments, systems, apparatus, methods and articles of manufacture provide for facilitating settlement of workers' compensation cases where the settlement of both compensation to an injured worker and any concurrent third party liability claim(s) made by the injured worker are being considered. Although embodiments of the invention are described with reference to workers' compensation insurance, systems, apparatus, methods and articles of manufacture according to the invention may have applicability in other transactions having a claim component and/or a subrogation component.

In accordance with some embodiments, systems, apparatus, methods and articles of manufacture provide for facilitating, creating, assessing, storing, receiving, simulating, transmitting, representing and/or modifying one or more negotiation scenarios (e.g., a simulated, proposed or actual global settlement offer of a carrier or claimant) for a settlement related to an insurance claim (e.g., a global settlement or global resolution).

Applicants have recognized that it may be advantageous, in accordance with some embodiments, to provide for projecting or simulating one or more scenarios (e.g., negotiation scenarios) for a global settlement related to a claim. In one or more embodiments, global settlement may be simulated based on one or more assumptions or projections about projected exposure and/or lien recovery (e.g., in advance of an actual action by a claimant against a third party and/or in advance of an actual settlement by a claimant with a third party). According to some embodiments, lien recovery amounts may be determined by any commercially reasonable method.

Applicants have further recognized that it may be advantageous, in accordance with some embodiments, to provide for determining a value of, determining an historical performance of, or otherwise assessing at least one finalized global settlement and/or reporting on an assessment of at least one finalized global settlement. Applicants have recognized that it may be advantageous to assess, for example, the business value to a carrier of one or more accepted global settlement offers (e.g., as may have been suggested by the carrier, by respective claimants and/or other parties). In one or more embodiments, assessing a measure of success of a global settlement offer may comprise determining respective settlement costs and/or settlement savings associated with at least one prior accepted global settlement.

In accordance with some embodiments, systems, apparatus, methods and articles of manufacture provide for determining whether to accept a global settlement offer (e.g., as may be determined by a carrier in accordance with various embodiments, or as may be received from a claimant). In accordance with some embodiments, systems, apparatus, methods and articles of manufacture provide for determining whether to transmit or otherwise provide an offer to a claimant to settle claim exposure and a lien recovery for a carrier (e.g., a global settlement).

In accordance with some embodiments, systems, apparatus, methods and articles of manufacture provide for determining a settlement value of ongoing claim exposure, determining a projected lien recovery amount and determining at least one global settlement offer to settle a claim matter and a lien recovery matter based on: (i) the settlement value of the ongoing claim exposure and (ii) the projected lien recovery amount. In at least one embodiment, determining the settlement value may comprise determining a present day value of ongoing claim exposure (e.g., indemnity and/or medical exposure). In some embodiments, determining the settlement value does not comprise determining a present day value of ongoing claim exposure and/or does not comprise determining a present day value of a settlement value.

In accordance with some embodiments, systems, apparatus, methods and articles of manufacture provide for determining a present day value of future claim exposure, determining a projected lien recovery amount and determining at least one global settlement offer to settle a claim matter and a lien recovery matter based on: (i) the present day value of the future claim exposure and (ii) the projected lien recovery amount.

In accordance with some embodiments, systems, apparatus, methods and articles of manufacture provide for determining a present day value of future claim exposure, determining a projected lien recovery amount, determining a global settlement offer to settle a claim matter and a lien recovery matter, and determining a value of the global settlement offer based on: (i) the present day value of the future claim exposure, and (ii) the projected lien recovery amount.

Applicants have recognized that, in accordance with some embodiments, it may be advantageous for a carrier to assess more accurately an overall exposure level of the carrier with respect to claims (e.g., by taking into account available statutory future credits and/or jurisdictional recovery limitations) that may be useful to strategic decision making (e.g., with respect to projecting funds required for reserve).

In accordance with some embodiments, systems, apparatus, methods and articles of manufacture provide for analyzing, assessing and/or reporting on at least one proposed global settlement offer, at least one simulated or hypothetical global settlement offer, at least one received global settlement offer and/or at least one finalized or accepted global settlement offer.

Throughout the description that follows and unless otherwise specified, the following terms may include and/or encompass the example meanings provided in this section. These terms and illustrative example meanings are provided to clarify the language selected to describe embodiments both in the specification and in the appended claims, and accordingly, are not intended to be limiting.

The term “insurance carrier” or “carrier”, as used herein, may refer to an insurance company or self-insured group or entity providing insurance coverage.

The term “claimant”, as used herein, may refer to an entity or person who has submitted a claim for benefits to a carrier, including an entity or person claiming to have suffered a loss or injury, a spouse or dependent(s) of a deceased person who claim benefits due to a loss by or injury to the deceased person. In one example, a claimant may be an employee claiming to have been injured in the course and scope of his employment for an insured employer of a carrier.

The term “third party”, as used herein, may refer to one or more persons or entities from which a claimant and/or insurance carrier is seeking to recover damages (e.g., based on a loss event). The term “third party defendant”, as used herein, may refer to a third party against whom a liability lawsuit has been brought by a claimant and/or insurance carrier. Although reference may be made to “third party defendant” in describing various embodiments and examples in this disclosure, it will be understood that, unless explicitly stated otherwise, it is contemplated that such embodiments and examples may be equally applicable to third parties other than third party defendants.

The term “third party recovery”, as used herein, may refer to a monetary amount or other value recovered or expected to be recovered by a party (e.g., a plaintiff, an injured claimant) from a third party, such as in a litigation and/or settlement proceeding.

The term “lien recovery amount”, as used herein, may refer to an amount of money recovered pursuant to a subrogation interest, such as, for example, a subrogation interest of an insurance carrier in a recovery by a claimant from a third party.

The term “negotiation scenario”, as used herein, may refer to information about a generated, contemplated, simulated, received (e.g., from a claimant), proposed and/or final settlement. Such information may include, without limitation, one or more of the following actual and/or projected values: an amount to settle ongoing benefits exposure, a lien amount, a maximum recoverable lien, an amount of exposure remaining after a lien is recovered, an amount to offer to settle some or all indemnity exposure, an amount to offer to settle (incurred and/or future) medical costs, an amount to offer to fund a Medicare Set Aside fund, an amount to offer to settle medical costs not qualified for a Medicare Set Aside fund, an amount of recovery, an amount of lien recovery, a total amount to pay out to achieve settlement (e.g., global settlement) and/or percentages of any such amounts (e.g., an offer for a settlement including 25% of a recovery from a third party defendant).

Although some examples in this disclosure may describe the generation or modification of one or more global settlement offers from the perspective of a carrier actively involved in actual negotiation with a claimant for global settlement, it will be readily understood that various embodiments contemplated by this disclosure may be used advantageously for simulating various scenarios for global settlement, even in advance of actual negotiations. Accordingly, negotiation scenarios and global settlement offers, as discussed herein, may be determined in the context of actual negotiation and settlement activity and/or for the purpose of simulating and evaluating the potential business value of future global settlement. In at least one embodiment, a determined global settlement offer does not necessarily have to be for submission to a claimant or have to be submitted to a claimant (i.e., it does not necessarily have to be offered), but may be considered (and potentially dismissed) or simulated for the purpose of assessing internally the potential value of such an offer to a carrier.

In one example, a negotiation scenario comprises information about an actual offer determined by or on behalf of a carrier (e.g., for presenting to a claimant) or received from a claimant (e.g., for consideration by a carrier). In another example, a negotiation scenario comprises information about a projected or simulated settlement negotiation (e.g., a “what if?” scenario), and may include and/or be based on information about projected or simulated values. For instance, determining a negotiation scenario or potential global settlement offer may comprise estimating or projecting a potential third party settlement amount and/or future exposure amounts, even before a claimant has filed suit against a third party defendant or before an actual third party settlement has been suggested or finalized.

The terms “global settlement” or “global resolution”, as used herein, may refer to settlement of two or more related matters. In one example, a global settlement refers to settlement of two or more matters related to a loss event, such as (1) a benefits claim (e.g., by a claimant for medical treatment costs for an injury) and (2) a subrogation lien or other interest (e.g., of an insurance carrier) in recovery from a third party defendant (e.g., resulting from settlement of a negligence lawsuit by an injured claimant).

The terms “present day value”, “present value” or “PDV”, as used herein, may refer to a present day value of a given monetary amount and/or the application of a present day value discount to a particular monetary amount. In some embodiments, determining PDV comprises determining how much money would be placed today in an interest bearing account to fund a known future payment stream (e.g., an annual benefit) over an expected period of time. PDV may be based on an assumed interest rate. In one example, the present day value of a future indemnity exposure may be less than the full expected payout over an expected period of time (e.g., the course of many years), as investment income may be generated on dollars held (e.g., in reserve) even while some amounts are paid out during period. It will be readily understood that, in accordance with some embodiments, an obligation to pay out a total amount over a future period of time reasonably may be valued at the present day value of the total obligation. For example, a carrier reasonably may consider offering no more than present day value of future lifetime indemnity exposure to settle a claimant's exposure claim.

The term “future indemnity exposure”, as used herein, may refer to an ongoing indemnity exposure and/or a value (monetary or otherwise) of future benefits to be paid under an indemnity policy (e.g., by an insurance carrier) to a claimant (e.g., an injured worker, or a spouse or dependent(s) of an injured worker). Future indemnity exposure may include costs and expenses associated with those benefits. In one example, in the context of a workers' compensation system, future indemnity exposure may refer to the benefits paid to an injured worker who has no ability to return to any gainful employment (e.g., permanent total disability), or to the widow of an injured worker who is deceased. In some embodiments, future indemnity exposure may be determined (e.g., by a computer and/or claim professional) by calculating or otherwise determining a value of benefits owed in a particular period of time (e.g., an annual benefit), and multiplying the determined value by the expected number of such periods. For example, an annual benefit may be multiplied by the projected number of future years of payment based on the life expectancy of an injured worker. In some embodiments, determining the future indemnity exposure may comprise determining the relevant total time of exposure (e.g., based on similar claims, based on an injury, based on a determination by a claim professional), such as for the life expectancy of an injured worker (or surviving spouse), or some shorter period of time. In some embodiments, determining a PDV of future indemnity exposure may comprise determining the future indemnity exposure (e.g., for a claim).

The terms “future medical exposure” or “future medical”, as used herein, may refer to an ongoing medical exposure and/or a value (monetary or otherwise) of future benefits to be paid (e.g., by an insurance carrier) to a claimant (e.g., an injured worker, or a spouse or dependent(s) of an injured worker) for cases involving a medical exposure. Future medical exposure may include costs and expenses associated with those benefits. In some embodiments, future medical exposure may be determined (e.g., by a computer and/or claim professional) by calculating or otherwise determining a value of medical benefits owed in a particular period of time (e.g., an annual medical benefit), and multiplying the determined value by the expected number of such periods. For example, an annual medical benefit may be multiplied by the projected number of future years of payment based on the life expectancy of an injured worker. In some embodiments, determining the future medical exposure may comprise determining the relevant total time of exposure (e.g., based on similar claims, based on an injury, based on a determination by a claim professional), such as for the lifetime of an injured worker, or some shorter period of time. In some embodiments, determining a PDV of future medical exposure may comprise determining the future medical exposure. It will be understood that there is no future medical exposure for a deceased person.

The terms “authorized % of settlement” or “authorized percentage of settlement”, as used herein, may refer to a percentage of a present value or settlement value (e.g., of a determined future exposure amount) authorized (e.g., by a carrier or representative of a carrier) for settlement or other claim resolution (e.g., with a claimant). The authorized % of settlement may depend, in some embodiments, on the particular facts of a claim. In one example, a claim professional may seek authority from one or more of various sources, including a supervisor, manager and/or a particular business unit relevant to the case (e.g., a major case unit for large exposure cases) to establish a particular authorized % of settlement. In one embodiment, the authorized % of settlement represents the percentage of a PDV of a total expected future exposure at which a carrier would be willing to settle a compensation case in the absence of a third party settlement or other subrogation interest. In some embodiments, an authorized % of settlement is an authorized % of a PDV settlement amount. 100% of settlement at PDV for a total exposure amount for a claim (e.g., for an injured worker in a workers' compensation case) would represent an expected “break even” scenario for a carrier—the carrier would be authorizing paying the same amount that the carrier would have retained to pay out over the life time of the claim, receiving the benefit of expected investment returns while the money remained in reserve. In accordance with some embodiments, Applicants have recognized that some types of carriers may find it advantageous (e.g., for the purpose of settlement negotiations and/or negotiation scenarios) to set an authorized % of settlement at less than one hundred percent (e.g., at 80%) in order to attempt to gain some savings in not paying the full PDV of a total expected future exposure (e.g., including future indemnity and/or future medical exposure).

As used herein, the term “statutory future credit” may refer to an insurance carrier's right to credit its obligation to pay future benefits (e.g., workers' compensation benefits) based on the amount of the claimant's third-party net recovery, or based on a formula set forth by the law of the relevant jurisdiction.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein a “network” is an environment wherein one or more computing devices may communicate with one another. Such devices may communicate directly or indirectly, via a wired or wireless medium such as the Internet, LAN, WAN or Ethernet (or IEEE 802.3), Token Ring, or via any appropriate communications means or combination of communications means. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present invention” and the like mean “one or more embodiments of the present invention.”

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present disclosure, including anything which may be incorporated by reference”, unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

“Determining” something can be performed in a variety of manners and therefore the term “determining” (and like terms) includes calculating, computing, deriving, looking up (e.g., in a table, database or data structure), ascertaining, recognizing, and the like.

A “display” as that term is used herein is an area that conveys information to a viewer. The information may be dynamic, in which case, an LCD, LED, CRT, Digital Light Processing (DLP), rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as Standard Definition Television (SDTV), Enhanced Definition TV (EDTV), High Definition TV (HDTV), or the like. The information may likewise be static, in which case, painted glass may be used to form the display. Note that static information may be presented on a display capable of displaying dynamic information if desired. Some displays may be interactive and may include touch screen features or associated keypads as is well understood.

The present disclosure may refer to a “control system”. A control system, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, Central Processing Unit (CPU) devices, computing devices, microcontrollers, digital signal processors, or like devices. Exemplary processors are the INTEL PENTIUM or AMD ATHLON processors.

The term “computer-readable medium” refers to any statutory medium that participates in providing data (e.g., instructions) that may be read by a computer, a processor or a like device. Such a medium may take many forms, including but not limited to non-volatile media, volatile media, and specific statutory types of transmission media. Non-volatile media include, for example, optical or magnetic disks and other persistent memory. Volatile media include DRAM, which typically constitutes the main memory. Statutory types of transmission media include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable memory” and/or “tangible media” specifically exclude signals, waves, and wave forms or other intangible or transitory media that may nevertheless be readable by a computer.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, and described methods may be depicted (e.g., in one or more flowcharts) as steps connected by directional arrows, such processes may be configured to work in different orders. In other words, any sequence or order of steps that may be explicitly described or depicted does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

It will be readily apparent that the various methods and algorithms described herein may be implemented by a control system and/or the instructions of the software may be designed to carry out the processes of the present invention.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software. Accordingly, a description of a process likewise describes at least one apparatus for performing the process, and likewise describes at least one computer-readable medium and/or memory for performing the process. The apparatus that performs the process can include components and devices (e.g., a processor, input and output devices) appropriate to perform the process. A computer-readable medium can store program elements appropriate to perform the method.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

1. A method, comprising:
determining, by a computer comprising at least one processor, a present day value of future claim exposure associated with an insurance claim;
determining, by the computer, a projected lien recovery amount associated with the insurance claim; and
determining, by the computer, at least one global settlement offer to settle a claim matter and a lien recovery matter associated with the insurance claim based on:
the present day value of the future claim exposure, and
the projected lien recovery amount.

2. The method of claim 1, wherein the computer comprises at least one of: a client computer, a server computer, and a data provider device.

3. The method of claim 1, wherein determining the present day value of the future claim exposure comprises determining a present day value of ongoing claim exposure based on at least one of:
a present day value of future indemnity exposure,
a present day value of future medical exposure, and
a statutory future credit.

4. The method of claim 1, wherein determining the present day value of the future claim exposure comprises transmitting a request for the future claim exposure from the computer to a second computer.

5. The method of claim 1, wherein determining the present day value of the future claim exposure comprises:
determining the future claim exposure; and
calculating the present day value of the future claim exposure based on the future claim exposure and a present day value factor.

6. The method of claim 1, wherein determining the projected lien recovery amount comprises determining the projected lien recovery amount based on at least one of:
a settlement amount from a third party defendant to a claimant, and
an amount of costs incurred by the claimant in a settlement with a third party defendant.

7. The method of claim 1, wherein determining the projected lien recovery amount comprises transmitting a request for the projected lien recovery amount from the computer to a second computer.

8. The method of claim 1, wherein determining the projected lien recovery amount comprises determining the projected lien recovery amount based on at least one of:
a recovery limit in a jurisdiction associated with the future claim exposure, and
an amount of funds available to a third party defendant.

9. The method of claim 1, further comprising determining a present day value of an authorized amount to settle ongoing claim exposure.

10. The method of claim 9, wherein determining the present day value of the authorized amount to settle ongoing claim exposure comprises determining an amount of continuing exposure during application of a statutory future credit.

11. The method of claim 9, wherein determining the present day value of the authorized amount to settle ongoing claim exposure comprises:
determining a statutory future credit amount;
determining an amount of benefits to be submitted by a claimant to exhaust the statutory future credit amount;
determining a percentage of benefits owed to a claimant during application of the statutory future credit amount; and
determining a maximum claim settlement value for settling the future claim exposure.

12. The method of claim 11, wherein determining the present day value of the authorized amount to settle ongoing claim exposure comprises:
determining that the amount of benefits to be submitted by a claimant to exhaust the statutory future credit amount is less than the maximum claim settlement value for settling the future claim exposure; and
determining the present day value of the authorized amount to settle ongoing claim exposure based on (i) the percentage of benefits owed to a claimant during application of the statutory future credit amount as applied to the amount of benefits to be submitted by a claimant to exhaust the statutory future credit amount and (ii) a difference between the maximum claim settlement value for settling the future claim exposure and the amount of benefits to be submitted by a claimant to exhaust the statutory future credit amount.

13. The method of claim 11, wherein determining the present day value of the authorized amount to settle ongoing claim exposure comprises:
determining that the amount of benefits to be submitted by a claimant to exhaust the statutory future credit amount is not less than the maximum claim settlement value for settling the future claim exposure; and
determining that the present day value of the authorized amount to settle ongoing claim exposure is equal to the percentage of benefits owed to a claimant during application of the statutory future credit amount as applied to the maximum claim settlement value for settling the future claim exposure.

14. The method of claim 11, wherein the present day value of the authorized amount to settle ongoing claim exposure is equal to the maximum claim settlement value for settling the future claim exposure.

15. The method of claim 9, wherein determining the at least one global settlement offer comprises determining the at least one global settlement offer based on the present day value of an authorized amount to settle ongoing claim exposure.

16. The method of claim 1, wherein determining the at least one global settlement offer comprises determining a present day value of future claim exposure remaining after recovery of the projected lien recovery.

17. The method of claim 1, wherein determining the at least one global settlement offer comprises determining at least one of: an offer to settle future indemnity exposure, an offer to fund a Medicare set aside, an offer to settle future medical exposure, and a negotiated lien recovery amount.

18. The method of claim 1, wherein determining the at least one global settlement offer comprises determining a global settlement cost.

19. The method of claim 18, wherein determining the global settlement cost comprises:
summing an offer component to settle future indemnity exposure, an offer component to fund a Medicare set aside, an offer component to settle future medical exposure to determine an amount to be paid out to a claimant on global settlement; and
subtracting a negotiated lien recovery amount from the determined amount to be paid out to the claimant on global settlement.

20. The method of claim 1, wherein determining the at least one global settlement offer comprises determining a global settlement savings.

21. The method of claim 20, further comprising determining that the global settlement savings is greater than a predetermined threshold savings value.

22. The method of claim 20, wherein determining the global settlement savings comprises determining the global settlement savings based on a global settlement cost and a present day value of future claim exposure remaining after recovery of the projected lien recovery.

23. The method of claim 1, further comprising transmitting to a user via a user interface an indication of a recommendation of at least one of the at least one global settlement offers.

24. The method of claim 1, further comprising receiving an indication of an acceptance by a claimant of one of the at least one global settlement offers.

25. The method of claim 24, further comprising storing in a database an indication of the accepted global settlement offer.

26. An apparatus comprising:
a processor; and
a computer-readable memory in communication with the processor, the computer-readable memory storing instructions that when executed by the processor result in:
determining a present day value of future claim exposure associated with an insurance claim;
determining a projected lien recovery amount associated with the insurance claim; and
determining at least one global settlement offer to settle a claim matter and a lien recovery matter associated with the insurance claim based on:
the present day value of the future claim exposure, and
the projected lien recovery amount.

27. A computer-readable memory storing instructions that when executed by a computer comprising at least one processor result in:
determining, by a computer comprising at least one processor, a present day value of future claim exposure associated with an insurance claim;
determining, by the computer, a projected lien recovery amount associated with the insurance claim; and
determining, by the computer, at least one global settlement offer to settle a claim matter and a lien recovery matter associated with the insurance claim based on:
the present day value of the future claim exposure, and
the projected lien recovery amount.

28. A method, comprising:
determining a present day value of future claim exposure associated with an insurance claim;
determining a projected lien recovery amount associated with the insurance claim;
determining, by a computer comprising at least one processor, a global settlement offer to settle a claim matter and a lien recovery matter associated with the insurance claim; and
determining, by the computer, a value of the global settlement offer based on:
the present day value of the future claim exposure, and
the projected lien recovery amount.

29. The method of claim 28, wherein determining the value of the global settlement offer comprises determining a global settlement savings based on:
a global settlement cost,
the present day value of the future claim exposure, and
the projected lien recovery amount.

30. The method of claim 29, further comprising determining that the global settlement savings is greater than a predetermined threshold savings value.

31. The method of claim 28, further comprising transmitting to a user via a user interface an indication of an approval of the global settlement offer based on the value of the global settlement offer.

32. The method of claim 31, wherein the global settlement offer is a prior accepted global settlement offer.

33. The method of claim 28,
wherein determining the global settlement offer comprises receiving the global settlement offer from a claimant; and
further comprising transmitting to a user via a user interface an indication of a recommendation to accept the received global settlement offer based on the value of the global settlement offer.

34. The method of claim 28, further comprising transmitting to a user via a user interface an indication of a recommendation to submit the global settlement offer to a claimant based on the value of the global settlement offer.

35. The method of claim 28, wherein the global settlement offer is a prior accepted global settlement offer.

36. The method of claim 35, further comprising:
determining a second global settlement offer that is a prior accepted global settlement offer;
determining a value of the second global settlement offer; and
determining a measure of global settlement performance based on the value of the global settlement offer and the value of the second global settlement offer.

37. The method of claim 36, wherein determining the measure of global settlement performance comprises at least one of (i) determining an average value of the global settlement value and the second global settlement value and (ii) determining an aggregate savings based on the global settlement offer and the second global settlement offer.

38. A method of determining a portion of an insurance settlement amount, comprising:
determining, by a computer comprising at least one processor, a present day value of future claim exposure associated with an insurance claim, comprising:
determining a present day value of ongoing claim exposure based on at least one of:
a present day value of future indemnity exposure,
a present day value of future medical exposure, and
a statutory future credit.

39. The method of claim 38, wherein at least one of the future indemnity exposure and the future medical exposure comprise costs and expenses associated with providing a benefit to a claimant.

40. The method of claim 38, further comprising:
determining, by the computer, a projected lien recovery amount associated with the insurance claim; and
determining, by the computer, at least one global settlement offer to settle a claim matter and a lien recovery matter associated with the insurance claim based on:
the present day value of the future claim exposure, and the projected lien recovery amount.
